(19) United States
(12) Patent Application Publication
(10) Pub. No.: US 2023/0189208 A1
(43) Pub. Date: Jun. 15, 2023

(54) PROCESSING METHOD OF AMF FOR SUPPORTING MULTIPLE USIMS

(71) Applicant: LG ELECTRONICS INC., Seoul (KR)

(72) Inventors: Laeyoung KIM, Seoul (KR); Sungduck CHUN, Seoul (KR); Myungjune YOUN, Seoul (KR)

(21) Appl. No.: 17/630,899

(22) PCT Filed: Jul. 10, 2020
(86) PCT No.: PCT/KR2020/009067

§ 371 Date: Jan. 27, 2022

(30) Foreign Application Priority Data
Aug. 8, 2019 (KR) 10-2019-0096826

(51) Int. Cl. H04W 68/02; H04W 76/30

(52) U.S. Cl. CPC H04W 68/02; H04W 76/30

(57) ABSTRACT

The present specification provides a method for processing, by an access and mobility management function (AMF) device in a first network, a request from a user equipment (UE). The method may comprise receiving, by the AMF device in the first network, a first request message from the UE that supports multiple universal subscriber identity modules (USIMs) and has received a paging message from a second network. The first request message may comprise information on one or more protocol data unit (PDU) sessions and information on release. The method may comprise transmitting a second message to a session management function (SMF) device in the first network. The second message may comprise information on the one or more PDU sessions based on the first request message. The method may comprise performing a procedure for releasing with a radio access network (RAN) in the first network.

### TECHNICAL FIELD

The present specification relates to mobile communications.

### BACKGROUND

With the success of Long-Term Evolution (LTE)/LTE-Advanced (LTE-A) for the fourth-generation mobile communication, the next generation mobile communication, which is the fifth-generation (so called 5G) mobile communication, has been attracting attentions and more and more researches are being conducted.

The fifth-generation communication defined by the International Telecommunication Union (ITU) refers to providing a maximum data transmission speed of 20 Gbps and a maximum transmission speed of 100 Mbps per user in anywhere. It is officially called “IMT-2020” and aims to be released around the world in 2020.

The fifth-generation mobile communication supports multiples numerologies (and/or multiple Subcarrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

NR frequency band is defined as a frequency range of two types, i.e., FR1, FR2. FR1 is 410 MHz-7125 MHz, and FR2 is 24250 MHz-52600 MHz, meaning millimeter wave (mmW).

For convenience of explanation, among the frequency ranges used in the NR system, FR1 may mean “sub 6 GHz range”. FR2 may mean “above 6 GHz range”, and may be referred to as millimeter Wave (mmW).

TABLE 1

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system can be changed. For example, FR1 may include a band of 410 MHz to 7125 MHz as shown in Table 2 below. That is, FR1 may include a frequency band of above 6 GHz (or, 5850, 5900, 5925 MHz, etc.). For example, a frequency band of above 6 GHz (or, 5850, 5900, 5925 MHz, etc.) included in FR1 may include an unlicensed band. The unlicensed band may be used for various purposes, e.g., for communication for a vehicle (e.g., autonomous driving).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The ITU suggests three usage scenarios, e.g., enhanced Mobile Broadband (eMBB), massive Machine Type Communication (mMTC), and Ultra-Reliable and Low Latency Communications (URLLC).

URLLC relates to a usage scenario in which high reliability and low delay time are required. For example, services like autonomous driving, automation, and virtual realities requires high reliability and low delay time (e.g., 1 ms or less). A delay time of the current 4G (LTE) is statistically 21-43 ms (best 10%), 33-75 ms (median). Thus, the current 4G (LTE) is not sufficient to support a service requiring a delay time of 1 ms or less.

Next, the eMBB relates to a usage scenario that requires a mobile ultra-wideband.

These ultra-wideband high-speed services seem to be difficult to accommodate by existing core networks designed for LTE/LTE-A.

Therefore, the redesign of core networks is urgently needed in so-called fifth-generation mobile communications.

FIG. 1 is a structural diagram of a next-generation mobile communication network.

The 5G Core network (5GC) may include various components, part of which are shown in FIG. 1, including an Access and mobility Management Function (AMF) 41, a Session Management Function (SMF) 42, a Policy Control Function (PCF) 43, a User Plane Function (UPF) 44, an Application Function (AF) 45, a Unified Data Management (UDM) 46 and a Non-3GPP Interworking Function (N3IWF) 49.

A UE 10 is connected to a data network via the UPF 44 through a Next Generation Radio Access Network (NG-RAN).

The UE 10 may be provided with a data service even through untrusted non-3GPP access, e.g., a Wireless Local Area Network (WLAN). In order to connect the non-3GPP access to a core network, the N3IWF 59 may be deployed.

FIG. 2 is an exemplary diagram illustrating a predicted structure of a next generation mobile communication in terms of a node.

Referring to FIG. 2, the UE is connected to a Data Network (DN) through a NG-RAN.

The Control Plane Function (CPF) node as shown may perform all or part of the Mobility Management Entity (MME) function of the fourth generation mobile communication, and all or a part of the control plane function of the Serving Gateway (S-GW) and the PDN-Gateway (P-GW) of the fourth generation mobile communication. The CPF node includes an Access and mobility Management Function (AMF) node and a Session Management Function (SMF).

The User Plane Function (UPF) node as shown is a type of a gateway over which user data is transmitted and received. The UPF node may perform all or part of the user plane functions of the S-GW and the P-GW of the fourth generation mobile communication.

The Policy Control Function (PCF) node as shown is configured to control a policy of the service provider.

The Application Function (AF) node as shown refers to a server for providing various services to the UE.

The Unified Data Management (UDM) node as shown refers to a type of a server that manages subscriber information, such as a Home Subscriber Server (HSS) of 4th generation mobile communication. The UDM node stores and manages the subscriber information in the Unified Data Repository (UDR).

The Authentication Server Function (AUSF) node as shown authenticates and manages the UE.

The Network Slice Selection Function (NSSF) node as shown refers to a node for performing network slicing as described below.

In FIG. 2, a UE can simultaneously access two data networks using multiple Protocol Data Unit (PDU) sessions.

FIG. 3 is an exemplary diagram illustrating an architecture for supporting simultaneously access two data networks.

FIG. 3 illustrates an architecture that allows the UE to simultaneously access two data networks using one PDU session.

Reference points shown in FIGS. 2 and 3 are as follows.

N1 is a reference point between UE and AMF.

N2 is a reference point between (R)AN and AMF.

N3 is a reference point between (R)AN and UPF.

N4 is a reference point between SMF and UPF.

N5 is a reference point between PCF and AF.

N6 is a reference point between UPF and DN.

N7 is a reference point between SMF and PCF.

N8 is a reference point between UDM and AMF.

N9 is a reference point between UPFs.

N10 is a reference point between UDM and SMF.

N11 is a reference point between AMF and SMF.

N12 is a reference point between AMF and AUSF.

N13 is a reference point between UDM and AUSF.

N14 is a reference point between AMFs.

N15 is a reference point between PCF and AMF.

N16 is a reference point between SMFs.

N22 is a reference point between AMF and NSSF.

FIG. 4 is another exemplary diagram showing a structure of a radio interface protocol between a UE and a gNB.

The radio interface protocol is based on the 3GPP radio access network standard. The radio interface protocol is horizontally composed of a physical layer, a data link layer, and a network layer, and is vertically divided into a user plane for transmission of data information and a control plane for transfer of control signal (signaling).

The protocol layers may be divided into L1 (first layer), L2 (second layer), and L3 layer (third layer) based on the lower three layers of the Open System Interconnection (OSI) reference model widely known in communication systems.

Hereinafter, each layer of the radio protocol will be described.

The first layer, the physical layer, provides an information transfer service using a physical channel. The physical layer is connected to an upper medium access control layer through a transport channel, and data between the medium access control layer and the physical layer is transmitted through the transport channel. In addition, data is transmitted between different physical layers, that is, between the physical layers of a transmitting side and a receiving side through a physical channel.

The second layer includes a Medium Access Control (MAC) layer, a Radio Link Control (RLC) layer, and a Packet Data Convergence Protocol (PDCP) layer.

The third layer includes Radio Resource Control (hereinafter abbreviated as RRC) layer. The RRC layer is defined only in the control plane and is in charge of control of logical channels, transport channels, and physical channels related to configuration, reconfiguration and release of radio bearers. In this case, RB refers to a service provided by the second layer for data transfer between the UE and the E-UTRAN.

The Non-Access Stratum (NAS) layer performs functions such as connection management (session management) and mobility management.

The NAS layer is divided into a NAS entity for Mobility Management (MM) and a NAS entity for Session Management (SM).

1) NAS entity for MM provides the following functions in general.

NAS procedures related to AMF include the following.
Registration management and access management procedures. AMF supports the following functions.
Secure NAS signal connection between UE and AMF (integrity protection, encryption)

2) The NAS entity for SM performs session management between the UE and the SMF.

The SM signaling message is processed, that is, generated and processed, at an NAS-SM layer of the UE and SMF. The contents of the SM signaling message are not interpreted by the AMF.
In the case of SM signaling transmission,
The NAS entity for the MM creates a NAS-MM message that derives how and where to deliver an SM signaling message through a security header representing the NAS transmission of SM signaling and additional information on a received NAS-MM.
Upon receiving SM signaling, the NAS entity for the SM performs an integrity check of the NAS-MM message, analyzes additional information, and derives a method and place to derive the SM signaling message.

Meanwhile, in FIG. 4, the RRC layer, the RLC layer, the MAC layer, and the PHY layer located below the NAS layer are collectively referred to as an Access Stratum (AS).

A network system (i.e., 5GC) for next-generation mobile communication (i.e., 5G) also supports non-3GPP access. An example of the non-3GPP access is typically a WLAN access. The WLAN access may include both a trusted WLAN and an untrusted WLAN.

In the system for 5G, AMF performs Registration Management (RM) and Connection Management (CM) for 3GPP access as well as non-3GPP access.

Meanwhile, in a 3GPP-based system (e.g., 4G network/5G network), it is basically assumed that one UE has one Universal Subscriber Identity Module (USIM).

However, among the actually released UEs, UEs supporting dual or multi USIM have been released. In particular, in some countries, UEs supporting multiple USIMs are mainstream.

However, since the operation for dual or multi USIM is not defined in the 3GPP standard, there is a problem in that the UE cannot communicate smoothly.

### SUMMARY

Accordingly, an object of the present specification is to propose a method for solving the above-described problems.

In order to solve the above-described problems, a disclosure of the present specification provides a method for an Access and mobility Management Function (AMF) device in a first network to process a request from a User Equipment (UE). The method may comprise receiving, by the AMF device in the first network, a first request message from the UE which supports multiple Universal Subscriber Identity Modules (USIMs) and has received a paging message from a second network. The first request message may include information on one or more Protocol Data Unit (PDU) sessions and information on release. The method may comprise transmitting, by the AMF device, a second message to a Session Management Function (SMF) device in the first network. The second message may include information on the one or more PDU sessions based on the first request message. The method may comprise performing, by the AMF device, a procedure for releasing with a Radio Access Network (RAN) in the first network.

In order to solve the above-described problems, a disclosure of the present specification provides an Access and mobility Management Function (AMF) device in a first network to process a request from a User Equipment (UE). The AMF device may comprise at least one processor, and at least one memory operably electrically connectable to the at least one processor and storing instructions. Based on being executed by the at least one processor, the instructions may perform operations comprising: receiving a first request message from the UE which supports multiple Universal Subscriber Identity Modules (USIMs) and has received a paging message from a second network; transmitting a second message to a Session Management Function (SMF) device in the first network, and performing a procedure for releasing with a Radio Access Network (RAN) in the first network. The first request message may include information on one or more Protocol Data Unit (PDU) sessions and information on release. The second message may include information on the one or more PDU sessions based on the first request message.

In order to solve the above-described problems, a disclosure of the present specification provides a non-volatile computer readable storage medium storing instructions. Based on being executed by at least one processor, the instructions may cause the at least one processor to perform operations comprising: receiving a first request message from the UE which supports multiple Universal Subscriber Identity Modules (USIMs) and has received a paging message from a second network, transmitting a second message to a Session Management Function (SMF) device in the first network, and performing a procedure for releasing with a Radio Access Network (RAN) in the first network. The first request message may include information on one or more Protocol Data Unit (PDU) sessions and information on release. The second message may include information on the one or more PDU sessions based on the first request message.

According to the disclosure of the present specification, it is possible to solve the problems of the prior art.

### BRIEF DESCRIPTION OF THE DRAWINGS

FIG. 1 is a structural diagram of a next-generation mobile communication network.

FIG. 2 is an exemplary diagram illustrating a predicted structure of a next generation mobile communication in terms of a node.

FIG. 3 is an exemplary diagram illustrating an architecture for supporting simultaneously access two data networks.

FIG. 4 is another exemplary diagram showing a structure of a radio interface protocol between a UE and a gNB.

FIGS. 5a and 5b are a signal flowchart illustrating an exemplary registration procedure.

FIGS. 6a and 6b are a signal flowchart illustrating an exemplary PDU session establishment procedure.

FIGS. 7a and 7b show a modification procedure for a PDU session.

FIG. 8 is an exemplary diagram illustrating an operation according to a first example of the first disclosure of the present specification.

FIG. 9 is an exemplary diagram illustrating an operation according to a second example of the first disclosure of the present specification.

FIG. 10 is an exemplary diagram illustrating an operation according to a third example of the first disclosure of the present specification.

FIG. 11 is an exemplary diagram illustrating an operation according to a first example of the second disclosure of the present specification.

FIG. 12 is an exemplary diagram illustrating an operation according to a second example of the second disclosure of the present specification.

FIG. 13 is an exemplary diagram illustrating an operation according to a third example of the second disclosure of the present specification.

FIG. 14 shows a block diagram of a processor in which the disclosure of the present specification is implemented.

FIG. 15 illustrates a wireless communication system according to an embodiment.

FIG. 16 illustrates a block diagram of a network node according to an embodiment.

FIG. 17 is a block diagram illustrating a configuration of a UE according to an embodiment.

FIG. 18 is a detailed block diagram illustrating the transceiver of the first device shown in FIG. 15 or the transceiver of the device shown in FIG. 17 in detail.

FIG. 19 illustrates a communication system 1 applied to the disclosure of the present specification.

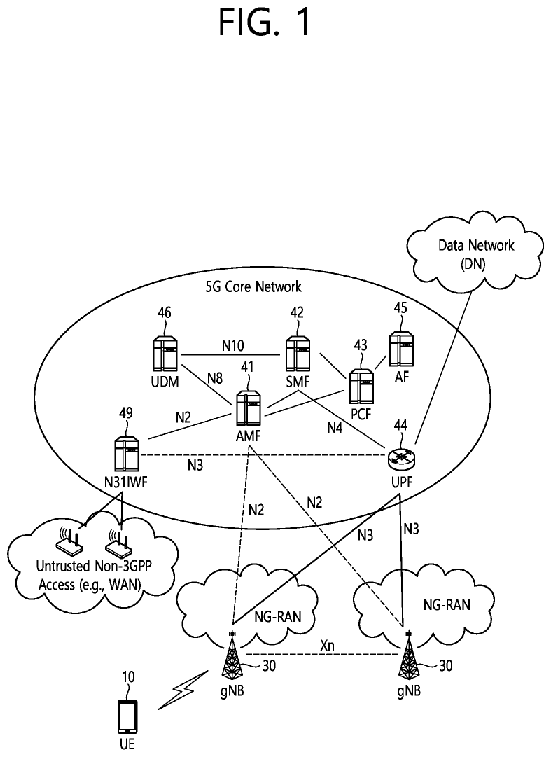

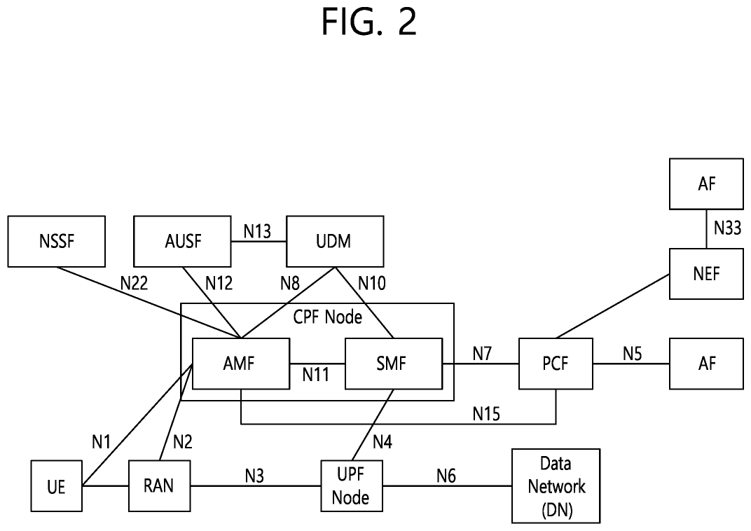

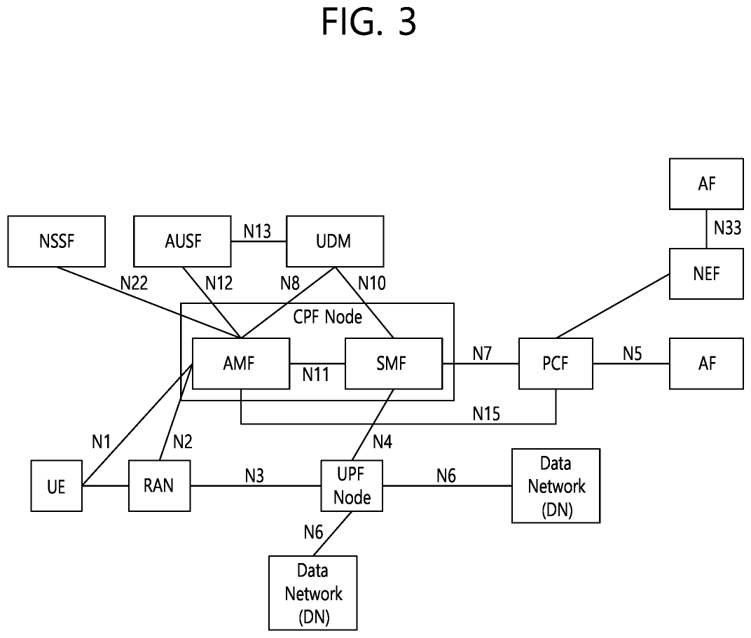

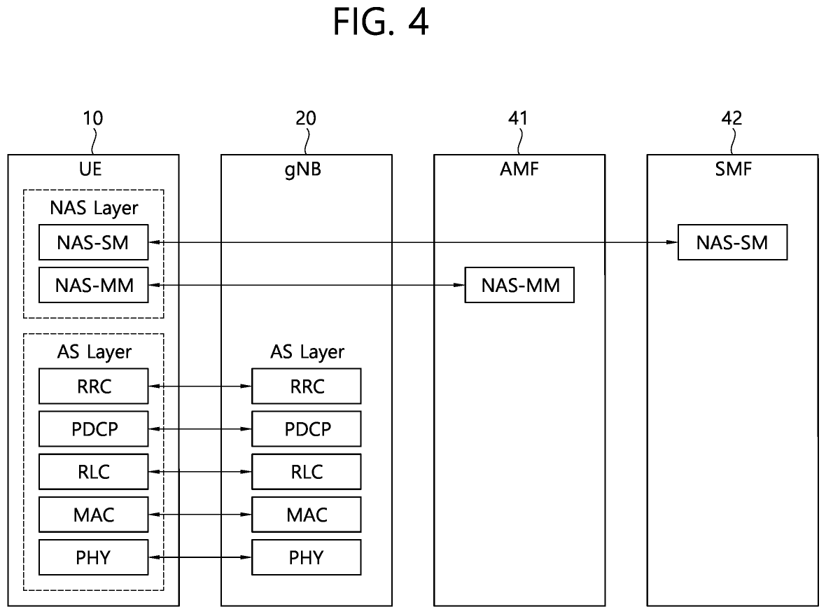

### DETAILED DESCRIPTION

The technical terms used herein are used to merely describe specific embodiments and should not be construed as limiting the present disclosure. Further, the technical terms used herein should be, unless defined otherwise, interpreted as having meanings generally understood by those skilled in the art but not too broadly or too narrowly. Further, the technical terms used herein, which are determined not to exactly represent the spirit of the disclosure, should be replaced by or understood by such technical terms as being able to be exactly understood by those skilled in the art. Further, the general terms used herein should be interpreted in the context as defined in the dictionary, but not in an excessively narrowed manner.

The expression of the singular number in the present disclosure includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the present disclosure, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present disclosure.

It will be understood that when an element or layer is referred to as being “connected to” or “coupled to” another element or layer, it may be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present disclosure will be described in greater detail with reference to the accompanying drawings. In describing the present disclosure, for ease of understanding, the same reference numerals are used to denote the same components throughout the drawings, and repetitive description on the same components will be omitted. Detailed description on well-known arts which are determined to make the gist of the disclosure unclear will be omitted. The accompanying drawings are provided to merely make the spirit of the disclosure readily understood, but not should be intended to be limiting of the disclosure. It should be understood that the spirit of the disclosure may be expanded to its modifications, replacements or equivalents in addition to what is shown in the drawings.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

In the accompanying drawings, a User Equipment (UE) is illustrated by way of example, but the illustrated UE may also be referred to in terms of UE 100 (terminal), Mobile Equipment (ME), etc. In addition, the UE may be a portable device such as a notebook computer, a mobile phone, a PDA, a smartphone, or a multimedia device or may be a non-portable device such as a PC or vehicle-mounted device.

### <Registration Procedure>

In order to allow mobility tracking and data reception to be performed, and in order to receive a service, the UE needs to gain authorization. For this, the UE shall register to a network. The registration procedure is performed when the UE needs to perform initial registration to a 5G system. Additionally, the Registration Procedure is performed when the UE performs periodic registration update, when the UE relocates to a new Tracking Area (TA) in an Idle state, and when the UE needs to perform periodic registration renewal.

During the initial registration procedure, an ID of the UE may be obtained from the UE. The AMF may forward (or transfer) a PEI (IMEISV) to a UDM, SMF, and PCF.

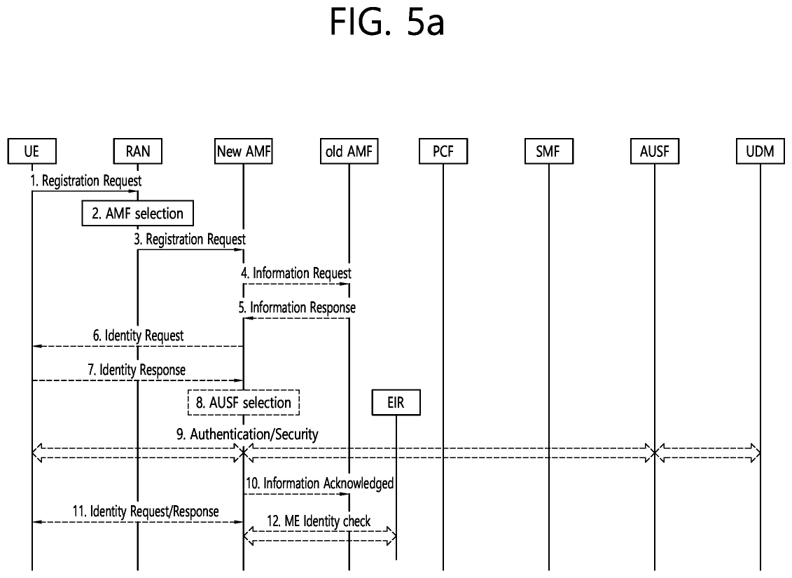

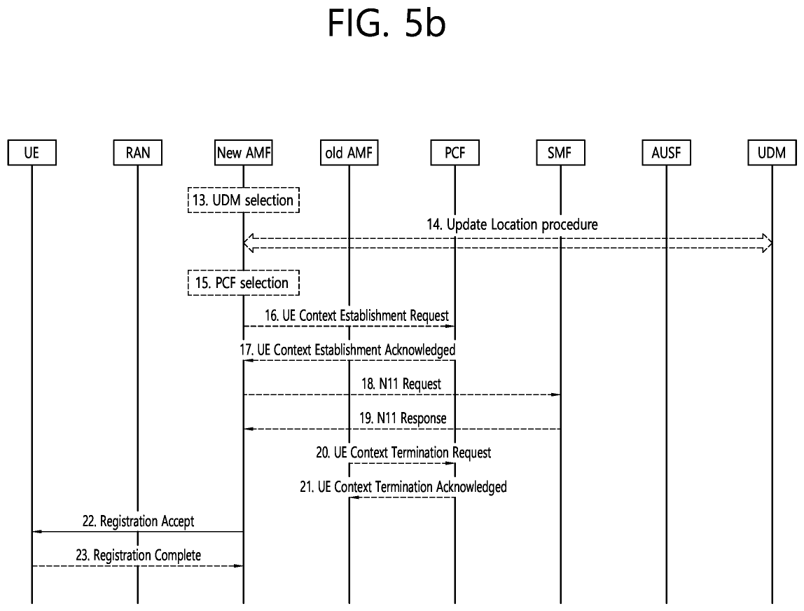

FIGS. 5a and 5b are a signal flowchart illustrating an exemplary registration procedure.)

1) The UE may transmit an AN message to the RAN. The AN message may include an AN parameter and a registration request message. The registration request message may include information, such as a register type, a subscriber permanent ID or temporary user ID, a security parameter, Network Slice Selection Assistance Information (NSSAI), 5G capability of the UE, a Protocol Data Unit (PDU) session status, and so on.

In case of a 5G RAN, the AN parameter may include a Subscription Permanent Identifier (SUPI) or a temporary user ID, a selected network, and NSSAI.

The registration type may indicate whether the registration is an “initial registration” (i.e., the UE is in a non-registered state), “mobility registration update” (i.e., the UE is in a registered state, and the registration procedure is initiated by mobility), or “periodic registration update” (i.e., the UE is in a registered state, and the registration procedure is initiated due to the expiration of a periodic update timer). In case a temporary user ID is included, the temporary user ID indicates a last serving AMF. In case the UE has already been registered in a Public Land Mobile Network (PLMN) other than the PLMN of a 3GPP access through a non-3GPP access, the UE may not provide a UE temporary ID, which is allocated by the AMF during a registration procedure through the non-3GPP access.

The security parameter may be used for authentication and integrity protection.

The PDU session status indicates a PDU session that is available (and previously configured) in the UE.

2) In case the SUPI is included, or in case the temporary user ID does not indicate a valid AMF, the RAN may select an AMF based on a (R)AT and NSSAI.

In case the (R)AN cannot select an appropriate AMF, any AMF is selected according to a local policy, and the registration request is forwarded (or transferred) by using the selected AMF. If the selected AMF cannot provide service to the UE, the selected AMF may select another AMF that is more appropriate for the UE.

3) The RAN transmits an N2 message to a new AMF. The N2 message includes an N2 parameter and a registration request. The registration request may include a registration type, a subscriber permanent identifier or temporary user ID, a security parameter, NSSAI, MICO mode default settings (or configuration), and so on.

When a 5G-RAN is used, the N2 parameter includes location information related to a cell in which the UE is camping, a cell identifier, and a RAT type.

If the registration type indicated by the UE is a periodic registration update, Process 4 to Process 17, which will be described in detail later on, may not be performed.

4) The newly selected AMF may transmit an information request message to the previous AMF.

In case the temporary user ID of the UE is included in a registration request message, and in case the serving AMF is changed after the last registration, a new AMF may include an information request message, which includes complete registration request information for requesting SUPI and MM context of the UE, to the previous (or old) AMF.

5) The previous (or old) AMF transmits an information response message to the newly selected AMF. The information response message may include SUPI, MM context, and SMF information.

More specifically, the previous (or old) AMF transmits an information response message including SUPI and MM context of the UE.
In case information on an active PDU session is included in the previous (or old) AMF, SMF information including SMF ID and PDU session ID may be included in the information response message of the previous (or old) AMF.

6) In case the SUPI is not provided by the UE, or in case the SUPI is not searched from the previous (or old) AMF, the new AMF transmits an Identity Request message to the UE.

7) The UE transmits an Identity Response message including the SUPI to the new AMF.

8) The AMF may determine to perform triggering of an AUSF. In this case, the AMF may select an AUSF based on the SUPI.

9) The AUSF may initiate authentication of the UE and the NAS security function.

10) The new AMF may transmit an information response message to the previous (or old) AMF.

If the AMF is changed the new AMF may transmit the information response message in order to verify the forwarding of UE MM context.
If the authentication/security procedure is failed, the registration is rejected, and the new AMF may transmit a rejection message to the previous (or old) AMF.

11) The new AMF may transmit an Identity Request message to the UE.

In case a PEI is not provided by the UE, or in case a PEI is not searched from the previous (or old) AMF, an Identity Request message may be transmitted in order to allow the AMF to search the PEI.

12) The new AMF checks an ME identifier.

13) If Process 14, which will be described later on, is performed, the new AMF selects a UDM based on the SUPI.

14) If the AMF is modified after the final registration, if valid subscription context of the UE does not exist in the AMF, or if the UE provides a SUPI, wherein the AMF does not refer to a valid context, the new AMF initiates an Update Location procedure. Alternatively, even in a case where a UDM initiates Cancel Location for the previous AMF, the Update Location procedure may be initiated. The previous (or old) AMF discards the MM context and notifies all possible SMF(s), and, after obtaining AMF-related subscription data from the UDM, the new AMF generates MM context of the UE.

In case network slicing is used, the AMF obtains allowed NSSAI based on the requested NSSAI and UE subscription and local policy. In case the AMF is not appropriate for supporting the allowed NSSAI, the registration request is re-routed.

15) The new AMF may select a PCF based on the SUPI.

16) The new AMF transmits a UE Context Establishment Request message to the PCF. The AMF may request an operator policy for the UE to the PCF.

17) The PCF transmits a UE Context Establishment Acknowledged message to the new AMF.

18) The new AMF transmits an N11 request message to the SMF.

More specifically, when the AMF is changed, the new AMF notifies the new AMF that provides services to the UE to each SMF. The AMF authenticates the PDU session status from the UE by using available SMF information. In case the AMF is changed, the available SMF information may be received from the previous (or old) AMF. The new AMF may send a request to the SMF to release (or cancel) network resources related to a PDU session that is not activated in the UE.

19) The new AMF transmits an N11 response message to the SMF.

20) The previous (or old) AMF transmits a UE Context Termination Request message to the PCF.

In case the previous (or old) AMF has previously requested UE context to be configured in the PCF, the previous (or old) AMF may delete the UE context from the PCF.

21) The PCF may transmit a UE Context Termination Request message to the previous (or old) AMF.

22) The new AMF transmits a Registration Accept message to the UE. The Registration Accept message may include a temporary user ID, registration area, mobility restriction, PDU session status, NSSAI, periodic registration update timer, and allowed MICO mode.

The registration accept message may include information on the allowed NSSAI and the mapped NSSAI. The information on the allowed NSSAI information for the UE's access type may be contained within N2 messages containing the registration accept message. The information on the mapped NSSAI is information for mapping each S-NSSAI of the allowed NSSAI to the S-NASSI of the NSSAI set up for HPLMN.

In case the AMF allocated a new temporary user ID, the temporary user ID may be further included in the Registration Accept message. In case the mobility restriction is applied to the UE, information indicating the mobility restriction may be additionally included in the Registration Accept message. The AMF may include information indicating the PDU session status for the UE in the Registration Accept message. The UE may remove any internal resource being related to a PDU session that is not marked as being active from the received PDU session status. If the PDU session status information is included in the Registration Request, the AMF may include the information indicating the PDU session status to the UE in the Registration Accept message.

23) The UE transmits a Registration Complete message to the new AMF.

### <PDU Session Establishment Procedure>

For the PDU Session Establishment procedure, two different types of PDU Session Establishment procedures may exist as described below.
A PDU Session Establishment procedure initiated by the UE.
A PDU Session Establishment procedure initiated by the network. For this, the network may transmit a Device Trigger message to an application (or applications) of the UE.

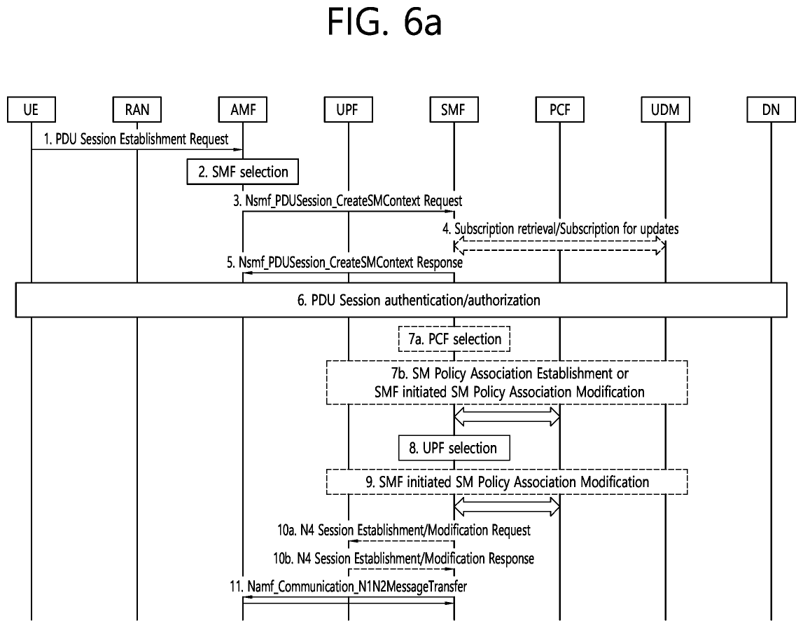

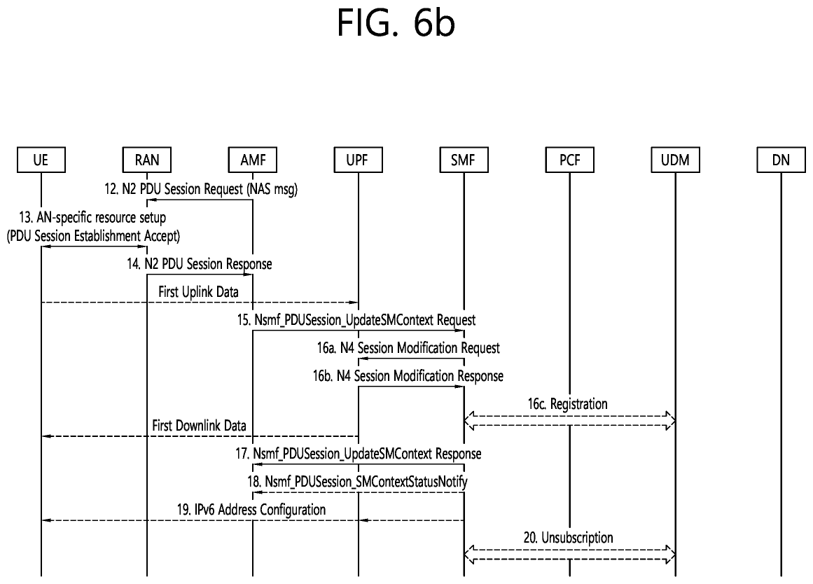

FIGS. 6a and 6b are a signal flowchart illustrating an exemplary PDU session establishment procedure.

The procedure shown in FIGS. 6a and 6b assumes that the UE has already registered on the AMF according to the registration procedure shown in FIGS. 5a and 5b. Therefore, it is assumed that the AMF has already acquired user subscription data from UDM.)

1) The UE transmits a NAS message to the AMF. The message may include Single-Network Slice Selection Assistance Information (S-NSSAI), DNN, PDU session ID, a Request type, N1 SM information, and so on.

Specifically, the UE includes S-NSSAI from allowed NSSAI for the current access type. If information on the mapped NSSAI has been provided to the UE, the UE may provide both S-NSSAI based on the allowed NSSAI and the corresponding S-NSSAI based on the information on the mapped NSSAI. Here, the information on the mapped NSSAI is information on mapping of each S-NSSAI in the allowed NSSAI to the S-NASSI in the NSSAI set up for HPLMN.

More specifically, the UE may extract and store the allowed NSSAI and the information on the mapped NSSAI, included in the registration accept message received from the network (i.e., AMF) in the registration procedure shown in FIG. 5. Therefore, the UE may transmit by including both S-NSSAI based on the allowed NSSAI and the corresponding S-NSSAI based on the information on the mapped NSSAI in the PDU session establishment request message.

In order to establish a new PDU session, the UE may generate a new PDU session ID.

By transmitting a NAS message having a PDU Session Establishment Request message included in N1 SM information, the PDU Session Establishment procedure that is initiated by the UE may be started. The PDU Session Establishment Request message may include a Request type, an SSC mode, and a protocol configuration option.

In case the PDU Session Establishment is for configuring a new PDU session, the Request type indicates “initial access”. However, in case an existing PDU session exists between the 3GPP access and the non-3GPP access, the Request type may indicate an “existing PDU session”.

The NAS message being transmitted by the UE is encapsulated within an N2 message by the AN. The N2 message is transmitted to the AMF and may include user location information and access technique type information.
The N1 SM information may include an SM PDU DN request container including information on a PDU session authentication performed by an external DN.

2) In case the request type indicates an “initial request”, and in case the PDU session ID has not been used for the existing PDU session of the UE, the AMF may determine that the message corresponds to a request for a new PDU session.

If the NAS message does not include the S-NSSAI, the AMF may determine default S-NSSAI for the requested PDU session according to the UE subscription. The AMF may relate a PDU session ID with an ID of the SMF and may store the PDU session ID.

The AMF may select SMF.

3) The AMF may transmit Nsmf_PDUSession_CreateSMContext Request message or Nsmf_PDUSession_UpdateSMContext Request message to the selected SMF.

The Nsmf_PDUSession_CreateSMContext Request message may include SUPI, DNN, S-NSSAI(s), PDU Session ID, AMF ID, Request Type, PCF ID, Priority Access, N1 SM container, User location information, Access Type, PEI, GPSI, UE presence in LADN service area, Subscription For PDU Session Status Notification, DNN Selection Mode, and Trace Requirements. The SM container may include a PDU Session Establishment Request message.

The Nsmf_PDUSession_UpdateSMContext Request message may include SUPI, DNN, S-NSSAI(s), SM Context ID, AMF ID, Request Type, N1 SM container, User location information, Access Type, RAT type, and PEI. The N1 SM container may include a PDU Session Establishment Request message.

The AMF ID is used to identify the AMF serving the UE. The N1 SM information may include a PDU session establishment request message received from the UE.

4) The SMF transmits a Subscriber Data Request message to the UDM. The Subscriber Data Request message may include a subscriber permanent ID and DNN. The UDM may transmit a Subscription Data Response message to the SMF.

In the above-described step 3, in case the Request type indicates an “existing PDU session”, the SMF determines that the corresponding request is caused by a handover between the 3GPP access and the non-3GPP access. The SMF may identify the existing PDU session based on the PDU session ID.

In case the SMF has not yet searched the SN-related subscription data for the UE that is related to the DNN, the SMF may request the subscription data.

The subscription data may include an authenticated Request type, an authenticated SSC mode, and information on a default QoS profile.

The SMF may verify whether or not the UE request follows the user subscription and local policy. Alternatively, the SMF may reject the UE request via NAS SM signaling (including the related SM rejection cause), which is forwarded (or transferred) by the AMF, and then the SMF may notify to the AMF that this shall be considered as a release of the PDU session ID.

5) The SMF transmits Nsmf_PDUSession_CreateSMContext Response message or Nsmf_PDUSession_UpdateSMContext Response message to the AMF.

The Nsmf_PDUSession_CreateSMContext Response message may include Cause, SM Context ID, or N1 SM container. The N1 SM container may include a PDU Session Reject.

In step 3 above, when the SMF has received the Nsmf_PDUSession_CreateSMContext Request message and the SMF can process the PDU Session establishment request message, the SMF creates SM context and the SM context ID is delivered to the AMF.

6) Secondary authentication/authorization is optionally performed.

7a) If the dynamic PCC is used for the PDU session, the SMF selects the PCF.

7b) The SMF performs an SM policy association establishment procedure in order to establish an SM policy association with the PCF.

8) If the request type in step 3 indicates “initial request”, the SMF selects the SSC mode for the PDU session. If step 5 is not performed, SMF may also select UPF. In case of the request type IPv4 or IPv6, the SMF may allocate an IP address/prefix for the PDU session.

9) The SMF provides information on the policy control request trigger condition by performing the SM policy association modification procedure.

10) If the request type indicates “initial request”, the SMF may start the N4 session establishment procedure using the selected UPF, otherwise may start the N4 session modification procedure using the selected UPF.

10a) The SMF transmits an N4 Session Establishment/Modification request message to the UPF. And, the SMF may provide packet discovery, execution, and reporting rules of packets that are to be installed in the UPF for the PDU session. In case the SMF allocates CN tunnel information, the CN tunnel information may be provided to the UPF.

10b) By transmitting an N4 Session Establishment/Modification response message, the UPF may respond. In case the CN tunnel information is allocated by the UPF, the CN tunnel information may be provided to the SMF.

11) The SMF transmits Namf_Communication_N1N2MessageTransfer message to the AMF. The Namf_Communication_N1N2MessageTransfer message may include PDU Session ID, N2 SM information, and N1 SM container.

The N2 SM information may include PDU Session ID, QFI(s), QoS Profile(s), CN Tunnel Info, S-NSSAI from the Allowed NSSAI, Session-AMBR, PDU Session Type, User Plane Security Enforcement information, UE Integrity Protection Maximum Data Rate.

The N1 SM container may include a PDU session establishment accept message.

The PDU session establishment accept message may include an allowed QoS rule, SSC mode, S-NSSAI, and an assigned IPv4 address.

12) The AMF transmits an N2 PDU Session Request message to the RAN. The message may include N2 SM information and an NAS message. The NAS message may include a PDU session ID and a PDU Session Establishment Accept message.

The AMF may transmit an NAS message including a PDU session ID and a PDU Session Establishment Accept message. Additionally, the AMF may include the N2 SM information received from the SMF in the N2 PDU Session Request message and may then transmit the message including the N2 SM information to the RAN.

13) The RAN may perform a specific signaling exchange with a UE being related to the information received from the SMF.

The RAN also allocates RAN N3 tunnel information for the PDU session.

The RAN forwards the NAS message, which is provided in the step 10. The NAS message may include a PDU session ID and N1 SM information. The N1 SM information may include a PDU Session Establishment Accept message.

The RAN transmits the NAS message to the UE only in a case where a needed RAN resource is configured and allocation of RAN tunnel information is successful.

14) The RAN transmits an N2 PDU Session Response message to the AMF. The message may include a PDU session ID, a cause, and N2 SM information. The N2 SM information may include a PDU session ID, (AN) tunnel information, and a list of allowed/rejected QoS profiles.
The RAN tunnel information may correspond to an access network address of an N3 tunnel corresponding to the PDU session.

15) The AMF may transmit Nsmf_PDUSession_UpdateSMContext Request message to the SMF. The Nsmf_PDUSession_UpdateSMContext Request message may include N2 SM information. Herein, the AMF may forward the N2 SM information received from the RAN to the SMF.

16a) If an N4 session for the PDU session has not already been configured, the SMF may start an N4 Session Establishment procedure along with the UPF. Otherwise, the SMF may use the UPF to start an N4 Session Modification procedure. The SMF may provide AN tunnel information and CN tunnel information. The CN tunnel information shall be provided only in a case where the SMF selects the CN tunnel information in the step 8.

16b) The UPF may transmit an N4 Session Modification Response message to the SMF.

17) The SMF transmits Nsmf_PDUSession_UpdateSMContext Response message to the AMF.

After this step, the AMF can deliver the related event to the SMF.

18) The SMF transmits Nsmf_PDUSession_SMContextStatusNotify message.

19) The SMF transmits information to the UE through the UPF. More specifically, in case of PDU Type IPv6, the SMF may generate an IPv6 Router Advertisement and may transmit the generated advertisement to the UE through the N4 and UPF.

20) During the procedure, if the PDU Session Establishment is not successful, the SMF notifies this to the AMF.

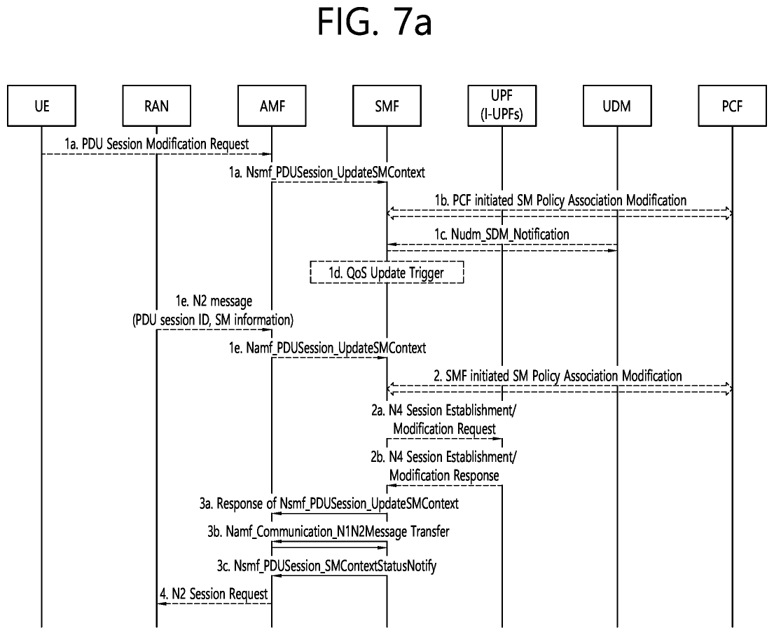

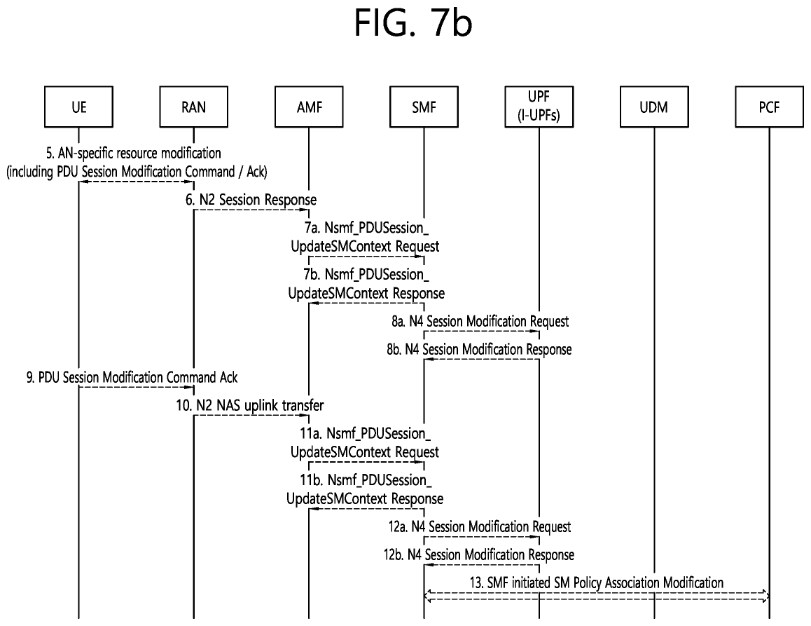

FIGS. 7a and 7b show a modification procedure for a PDU session.

The MA PDU session may be established/managed based on the PDU session modification procedure.

The PDU session modification procedure may be initiated by the UE or may be initiated by the network.

1a) When initiated by the UE, the UE may initiate a PDU session modification procedure by sending a NAS message. The NAS message may include an N1 SM container. The N1 SM container may include a PDU session modification request message, a PDU session ID, and information on the maximum data rate for integrity protection of the UE. The PDU session modification request message may include a PDU session ID, packet filters, requested QoS information, 5GSM core network capabilities, and the number of packet filters. The maximum data rate for integrity protection of the UE indicates the maximum data rate at which the UE can support UP integrity protection. The number of packet filters indicates the number of packet filters supported for QoS rules.

The NAS message is transmitted to an appropriate AMF according to the location information of the UE via the RAN. Then, the AMF transmits an Nsmf_PDUSession_UpdateSMContext message to the SMF. The message may include a Session Management (SM) context ID and an N1 SM container. The N1 SM container may include a PDU session modification request message.

1b) When initiated by the PCF among network nodes, the PCF may inform the SMF of the policy change by initiating an SM policy association modification procedure.

1c) When initiated by the UDM among the network nodes, the UDM may update the subscription data of the SMF by transmitting a Nudm_SDM_Notification message. The SMF may update the session management subscriber data and transmit an ACK message to the UDM.

1d) When initiated by SMF among network nodes, SMF may trigger QoS update.

When triggered according to 1a to 1d above, the SMF may perform a PDU session modification procedure.

1e) When initiated by an AN among network nodes, the AN may notify the SMF when an AN resource to which a QoS flow is mapped is released. The AN may transmit an N2 message to the AMF. The N2 message may include a PDU session ID and N2 SM information. The N2 SM information may include QFI, user location information, and an indication indicating that the QoS flow is released. The AMF may transmit an Nsmf_PDUSession_UpdateSMContext message. The message may include SM context ID and N2 SM information.

2) The SMF may transmit a report on the subscription event by performing the SM policy association modification procedure. If the PDU session modification procedure is triggered by 1b or 1d, this step may be skipped. If a dynamic PCC is not deployed in the network, the SMF may apply an internal policy to decide to change the QoS profile.

Steps 3 to 7, which will be described later, may not be performed when the PDU session modification requires only the UPF operation.

3a) When initiated by the UE or AN, the SMF may respond to the AMF by sending an Nsmf_PDUSession_UpdateSMContext message. The message may include N2 SM information and an N2 SM container. The N2 SM information may include a PDU session ID, QFI, QoS profile, and session-AMBR. The N1 SM container may include a PDU session modification command. The PDU session modification command may include a PDU session ID, a QoS rule, a QuS rule operation, QoS flow level QoS parameters, and a session-AMBR.

The N2 SM information may include information to be transmitted by the AMF to the AN. The N2 SM information may include a QFI and a QoS profile to notify the AN that one or more QoS flows are added or modified. If the PDU session modification is requested by the UE for which the user plane resource is not configured, the N2 SM information to be delivered to the AN may include information on the establishment of the user plane resource.

The N1 SM container may include a PDU session modification command to be delivered by the AMF to the UE. The PDU session modification command may include QoS rules and QoS flow level QoS parameters.

3b) When initiated by the SMF, the SMF may transmit a Namf_Communication_N1N2MessageTransfer message. The message may include N2 SM information and N1 SM container. The N2 SM information may include a PDU session ID, QFI, QoS profile, and session-AMBR. The N1 SM container may include a PDU session modification command. The PDU session modification command may include a PDU session ID, a QoS rule, and a QoS flow level QoS parameters.

If the UE is in the CM-IDLE state and ATC is activated, the AMF updates and stores the UE context based on the Namf_Communication_N1N2MessageTransfer message, and then steps 3 to 7 described later may be skipped. When the UE enters the reachable state, i.e., the CM-CONNECTED state, the AMF may transmit an N1 message to synchronize the UE context with the UE.

4) The AMF may transmit an N2 PDU session request message to the AN. The N2 PDU session request message may include N2 SM information received from the SMF and a NAS message. The NAS message may include a PDU session ID and an N1 SM container. The N1 SM container may include a PDU session modification command.

5) The AN performs AN signaling exchange with the UE related to the information received from the SMF. For example, in the case of NG-RAN, in order to modify the necessary AN resources related to the PDU session, an RRC connection reconfiguration procedure may be performed with the UE.

6) The AN transmits an N2 PDU session ACK message in response to the received N2 PDU session request. The N2 PDU session ACK message may include N2 SM information and user location information. The N2 SM information may include a list of accepted/rejected QFIs, AN tunnel information, and a PDU session ID.

7) The AMF delivers the N2 SM information and user location information received from the AN to the SMF through the Nsmf_PDUSession_UpdateSMContext message. Then, the SMF delivers the Nsmf_PDUSession_UpdateSMContext message to the AMF.

8) The SMF transmits an N4 session modification request message to the UPF to update the N4 session of the UPF included in the PDU session modification.

When a new QoS flow is generated, the SMF updates the UL packet detection rule of the new QoS flow together with the UPF.

9) The UE transmits a NAS message in response to receiving the PDU session modification command. The NAS message may include a PDU session ID and an N1 SM container. The N1 SM container may include a PDU session modification command ACK.

10) The AN transmits the NAS message to the AMF.

11) The AMF may deliver the N1 SM container and user location information received from the AN to the SMF through an Nsmf_PDUSession_UpdateSMContext message. The N1 SM container may include a PDU session modification command ACK. The SMF may deliver an Nsmf_PDUSession_UpdateSMContext response message to the AMF.

12) The SMF transmits an N4 session modification request message to the UPF to update the N4 session of the UPF included in the PDU session modification. The message may include an N4 session ID.

13) When the SMF interacts with the PCF in step 1b or step 2 above, the SMF may inform the PCF whether or not the PCC decision can be performed through the SM policy association modification procedure.

The SMF may notify the requesting entity for user location information related to the change of the PDU session.

### Problems to be Solved by the Disclosure of the Present Specification

In a 3GPP-based system (e.g., 4G network/5G network), it is basically assumed that one UE has one Universal Subscriber Identity Module (USIM). However, among the actually released UEs, UEs supporting dual or multi USIM have been released.

In particular, in some countries, UEs supporting multiple USIMs are mainstream, and since 3GPP standards do not support them, UEs implement a dual standby method to support multiple USIMs.

That is, the UE simultaneously registers with the network using both USIMs. Thereafter, the UE switches a Radio Frequency (RF) chain as needed to perform a service with a network. In this method, in general, the user directly sets which service to receive through which USIM, so the UE switches the RF unit based on the user setting.

In the case of Mobile Originating (MO) traffic, the UE may operate based on the user's settings, but in the case of Mobile Terminating (MT) traffic, a problem may occur. For example, when the UE registers with PLMN1 and PLMN2 through each USIM respectively, in the idle state, the UE needs to monitor both paging. However, if the Paging Occasion (PO) of PLMN1 and PLMN2 overlaps, the UE may monitor only one PLMN at a time. For this reason, even though an important service (e.g., voice call) needs to be made to the user, a situation may occur in which the UE cannot receive the service while monitoring another PLMN.

In addition to these problems, while the UE is receiving a service in PLMN1, paging monitoring for PLMN2 is not performed, and therefore, it cannot respond to paging. In this case, since the paging message for the UE is repeatedly retransmitted in PLMN2, a problem in that paging resources are wasted occurs.

In addition, if the UE continues to communicate with PLMN1, the UE cannot perform registration update in PLMN2, problems in which deregistration occurs in PLMN2 or mobility registration is not properly performed, so that the location of the UE cannot be properly identified in the network may occur.

In order to solve these problems, research is being conducted to efficiently support a UE supporting multiple USIMs in 3GPP SAE

In addition, in 3GPP SA2, research is being conducted on an operation method for a UE supporting multiple USIM (MUSIM).

### DISCLOSURE OF THE PRESENT SPECIFICATION

The disclosures of the present specification provide methods for solving the above-described problems.

The service processing method for a UE having a plurality of USIMs disclosed in the present specification consists of a combination of one or more of the following operations/configurations/steps. For reference, in the present specification, User Equipment (UE) and a terminal are used interchangeably.

In addition, USIM and SIM are used interchangeably.

Specifically, while in a state (i.e., the connected state) in which the UE is receiving a service from the first PLMN based on the first USIM (e.g., USIM a), when the UE is provided/informed from the network that the Mobile Terminated (MT) service has occurred in the second PLMN based on the second USIM (e.g., USIM b), the disclosure of the present specification proposes a method in which the UE suspends active communication activated through the first USIM. Being provided/informed from the network that the MT service has occurred may typically be that the UE receives a paging message. Hereinafter, it will be described that the UE is provided/informed from the network that the MT service has occurred through a paging message. However, the present disclosure is not limited thereto, and the UE may be provided/informed from the network that the MT service has occurred in various ways.

As described above, when the MT service occurs in the second PLMN based on the second USIM (e.g., USIM b), the UE may suspend communication activated in the first PLMN based on the first USIM, but regardless of whether MT service has occurred in the second PLMN based on the second USIM, communication activated in the first PLMN based on the first USIM may be suspended by the user. For example, if the user decides/selects to receive service from the second PLMN based on the second USIM while receiving the service from the first PLMN based on the first USIM, communication activated in the first PLMN based on the first USIM may be suspended.

One disclosure of the present specification proposes a method for the UE to receive a service from a second PLMN based on a second USIM by suspending communication activated in the first PLMN based on the first USIM and then resume the suspended communication.

In the disclosures of the present specification, the first PLMN based on the first USIM and the second PLMN based on the second USIM may belong to (or be owned by) the same PLMN (or MNO), or may belong to (or may be owned by) different PLMNs (or MNO).

Each of the drawings shows an embodiment of each disclosure, but the embodiments of the drawings may be implemented in combination with each other.

### I. First Disclosure of the Present Specification: A Method for Suspending Active Communication

Active communication may be interpreted as all services requiring suspension, ongoing services, PDU sessions with user plane activated, services with ongoing traffic, ongoing (IMS) sessions, active (IMS) sessions, ongoing applications, active applications, etc. This applies throughout the present specification.

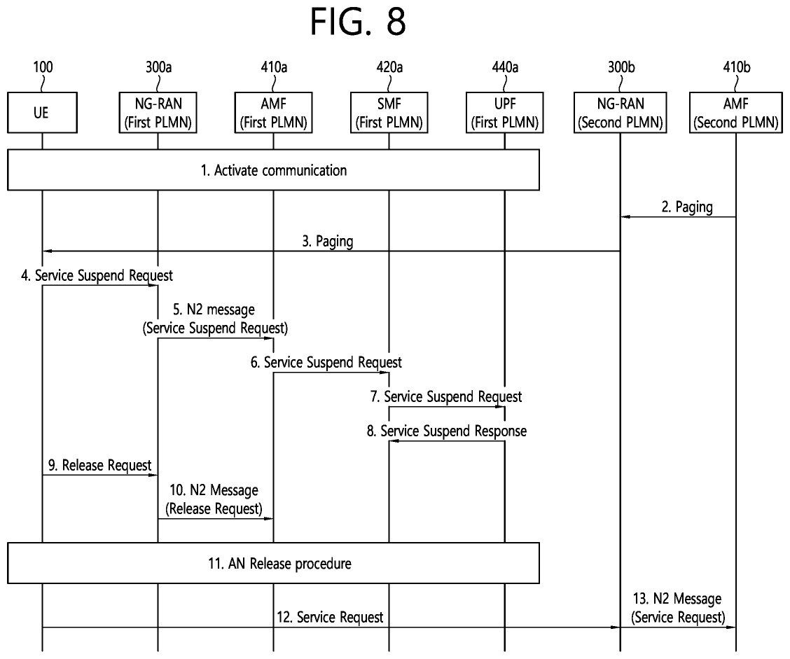

FIG. 8 is an exemplary diagram illustrating an operation according to a first example of the first disclosure of the present specification.

The first example of the first disclosure shown in FIG. 8 relates to a method of suspending active communication using a NAS message for Session Management (SM). This can be applied to both non-IMS services and IMS services.

In FIG. 8, the NG-RAN 300a, AMF 410a, SMF 420a, and UPF 440a may belong to the first PLMN, e.g., HPLMN or VPLMN, of the first USIM (e.g., USIM a) of the UE 100.

In addition, the NG-RAN 300b and the AMF 410b may belong to the second PLMN, e.g., HPLMN or VPLMN, registered based on the second USIM of the UE 100.

In FIG. 8, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different. An operation for the UE 100 to register to each PLMN and an operation for the UE 100 to create a PDU session will be referred to in FIGS. 5 and 6.

1) The UE 100 is receiving a service using the first USIM. That is, active communication exists in the first PLMN to which the UE 100 registered based on the first USIM. For example, the UE 100 may be downloading a sound source using the application #1 in the first PLMN registered based on the first USIM.

2) A Mobile Terminating (MT) service for the second USIM of the UE 100 occurs. Since the UE 100 is in an idle state in the second PLMN registered based on the second USIM, the AMF 410b of the second PLMN performs a paging procedure. For example, the AMF 410b of the second PLMN may transmit a paging message to the NG-RAN 300b of the second PLMN. The MT service may include both MT data (or MT user traffic) and MT signals.

3) The NG-RAN 300b receiving the paging message from the AMF 410b of the second PLMN transmits the paging message to the UE 100.

4) The UE 100 determines to respond to the received paging message. This determination may be performed according to, e.g., an input/selection provided by a user based on information in the paging message received from the second PLMN registered based on the second USIM (e.g., information on which MT service has occurred, which may include at least one of voice calls, video calls, SMS, other data service, etc.) or an input/selection based on UE preference/policy (priority) setting. However, this is only an example, and the response to the received paging message is not limited thereto, and may be determined based on various/complex inputs.

According to the above determination (determination to respond to the paging message related to the MT service occurred by the second USIM), the UE 100 transmits a request message, e.g., a Service Suspend Request message, for suspending active communication to the SMF 420a of the first PLMN. The Service Suspend Request message is transmitted to the SMF 420a through the NG-RAN 300a of the first PLMN and the AMF 410a of the first PLMN.

The UE 100 transmits the Service Suspend Request message to the related SMF 420a for the PDU session used by the active communication. Accordingly, if there are multiple active communications to be suspended and multiple PDU sessions are used, the UE 100 transmits the message for all of the corresponding PDU sessions, i.e., to all SMFs managing/serving the corresponding PDU sessions.

The Service Suspend Request message may include one or more of the following information. The information below may be included, either implicitly or in combination.

i) PDU session ID

ii) QFI(s) information: This may be interpreted as information on the QoS flow used for active communication to be suspended.

iii) Packet filter-related information: This may be interpreted as packet filter-related information (in part or all) that can represent active communication to be suspended.

iv) URSP-related information: This may be interpreted as URSP-related information (in part or all) that can represent active communication to be suspended.

v) Service-related information: This may be in the form of, e.g., a voice service, a video service, SMS, USSD, etc., and may be expressed in various granularities. This may be application information.

vi) Information requesting to suspend active communication

A new Session Management (SM) NAS message called the Service Suspend Request may be defined and used, or an existing SM NAS message may be extended and used as a request message for suspending active communication.

In addition, as the Service Suspend Request message is transmitted to the SMF 420a through the AMF 410a, in the NAS message including the Service Suspend Request, the UE 100 may include information necessary for the AMF 410a to process the SM NAS message, including the PDU session ID. For example, the AMF 410a may include the N1 SM container corresponding to the Service Suspend Request in the NAS message as follows.

### NAS Message (PDU Session ID, N1 SM Container (Service Suspend Request))

The UE 100 may store information on active communication that has been suspended (or requested to be suspended).

5) NG-RAN 300a transmits the NAS message received from the UE 100 to the AMF 410a.

6) The AMF 410a transmits the Service Suspend Request message to the SMF 420a. In this case, an existing or newly defined Nsmf service operation may be used to transmit the message to the SMF 420a. Here, the newly defined Nsmf service operation may be an operation related to suspension of active communication.

7) The SMF 420a requests/instructs the UPF 440a to suspend active communication. In this case, the existing N4 message may be extended and used for requesting/instructing suspension of active communication, or a new N4 message may be defined and used for requesting/instructing suspension of active communication. By requesting/instructing the UPF 440a to suspend active communication, the UPF 440a no longer transmits/forwards traffic corresponding to the suspended active communication. The traffic may be downlink traffic and/or uplink traffic. And, even if downlink traffic corresponding to the suspended active communication occurs (i.e., even if the UPF 440a receives downlink traffic corresponding to the suspended active communication), the UPF 440a does not transmit Data Notification to the SMF 420a. In addition to not transmitting/forwarding traffic anymore, the traffic may be dropped or buffered. The buffering may be performed only for a preset time.

Upon request from the UPF 440a, the SMF 420a may provide the information received from the UE 100 to the UPF 440a as it is, or may transform the information received from the UE 100 and provide it to the UPF 440a. When the SMF 420a receives from the UE 100 one or more of ‘ii) QFI(s) information’, ‘iii) packet filter-related information’, ‘iv) URSP-related information’, and ‘v) service-related information’ described in step 4 above, the SMF 420a may provide the information by transforming it into an information form that the UPF 440a can understand. That is, the UPF 440a may suspend active communication based on the information provided by the SMF 420a.

For example, when the UPF 440a receives ‘ii) QFI(s) information’, it may be interpreted as suspending a QoS flow related to active communication. When the UPF 440a receives ‘iii) packet filter-related information’, it may be interpreted as suspending a packet corresponding to a packet filter related to active communication. When the UPF 440a receives ‘iv) the URSP-related information’, it may be understood as suspending the packet indicated by the URSP related to active communication.

The UE 100 and/or the SMF 420a may cause the UPF 440a, based on the ongoing traffic for the UE 100, i.e., by detecting the ongoing traffic, to suspend active communication for the ongoing traffic. Or, the UE 100 and/or the SMF 420a may cause the UPF 440a to suspend all services/traffic for the UE 100. Or, the UE 100 and/or the SMF 420a may cause the UPF 440a to suspend the PDU session itself of the UE 100. For example, by not providing the UPF 440a with information ii) to v) of step 4 above or information derived therefrom, or by instructing the UPF 440a to operate as described above, the UE 100 and/or the SMF 420a may cause UPF 440a to adjust suspension target (e.g., active communication for ongoing traffic for the UE 100, all services/traffics for the UE 100 or PDU session itself).

In the above, the SMF 420a may perform an operation of deactivating the user plane (N3) after requesting suspension from the UPF 440a, or the suspension operation may be performed as part of the operation of deactivating the user plane (N3).

8) The UPF 440a transmits a response to the Service Suspend Request to the SMF 420a.

Although not shown, the SMF 420a may transmit a response to the Service Suspend Request to the AMF 410a. In addition, the SMF 420a may transmit a response to the Service Suspend Request to the UE 100.

9-10) The UE 100 transmits to the AMF 410a a NAS message, e.g., Release Request message, for requesting to switch to an idle mode for the first PLMN registered based on the first USIM. The NAS message is transmitted to the AMF 410a via the NG-RAN 300a. The new Mobility Management (MM) NAS message called the Release Request message may be defined and used as a NAS message requesting to switch to the idle mode, or the existing MM NAS message may be extended and used as a NAS message requesting to switch to the idle mode.

Although it is illustrated in FIG. 8 that the Release Request message is transmitted after step 8, this is only an example. The UE 100 may transmit the Release Request message immediately after step 4 or simultaneously with step 4.

Alternatively, the UE 100 may transmit the Release Request message after receiving a response (or ACK) to the Service Suspend Request message from the network after step 4 above.

Instead of requesting to switch to the idle mode for the first PLMN registered based on the first USIM from the AMF 410a using the NAS message, the UE 100 may request this from the NG-RAN 300a. In order to transmit the Service Suspend Request message of step 4, the UE 100 transmits an RRC message (i.e., ULInformationTransfer) including the Service Suspend Request message, and at this time, the UE 100 may perform an operation for requesting to switch to the idle mode for the first PLMN registered based on the first USIM from the NG-RAN 300a by transmitting the NG-RAN 300a including information requesting AN release. If the UE 100 needs to transmit a plurality of RRC messages to transmit the Service Suspend Request message, the UE 100 may include the information requesting AN release in the last RRC message (or the first RRC message, or any message among the plurality of RRC messages). Alternatively, an existing RRC message other than ULInformationTransfer may be extended and used for requesting to switch to the idle mode, or a new RRC message may be defined and used for requesting to switch to the idle mode. The NG-RAN 300a receiving the request to switch to the idle mode from the UE 100 performs the AN release procedure. It can be understood that the NG-RAN 300a performs the AN release procedure instead of the AMF 410a performing the AN release procedure described in step 11.

11) The AMF 410a performs an Access Network (AN) release procedure.

The AN release procedure may be initiated by the NG-RAN 300a due to deactivation (i.e., user deactivation) according to the UE 100 suspending active communication without requesting the network to switch to the idle mode as described above. For example, the UE 100 may naturally go to the idle mode, or may be intentionally made to go to the idle mode after suspension. However, after waiting until the deactivation timer expires in the NG-RAN 300a, the NG-RAN 300a performs the AN release procedure.

12-13) The UE 100 performs a service request procedure in order to respond to the paging message received from the PLMN registered using the second USIM. Accordingly, a Service Request message is transmitted to the AMF 410b through the NG-RAN 300b.

If the UE 100 receives the paging message, but the UE 100 is in the connected mode without active communication in the PLMN registered through the first USIM, the UE 100 performs from step 9. That is, if the UE 100 is in the connected state without active communication in the PLMN registered through the first USIM, the UE 100 may skip steps 4 to 8 without performing.

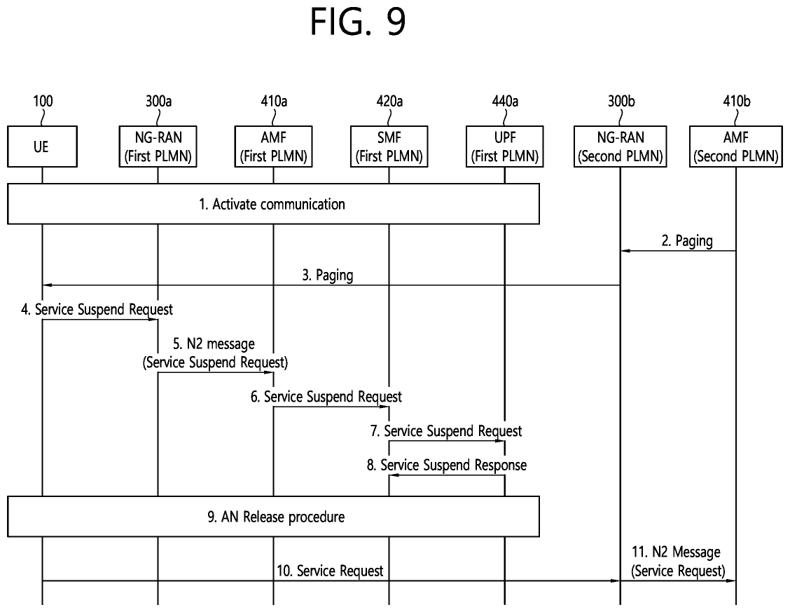

FIG. 9 is an exemplary diagram illustrating an operation according to a second example of the first disclosure of the present specification.

The second example of the first disclosure shown in FIG. 9 relates to a method of suspending active communication using a NAS message for Mobility Management (MM). This can be applied to both non-IMS services and IMS services.

In FIG. 9, the NG-RAN 300a, AMF 410a, SMF 420a, and UPF 440a may belong to the first PLMN, e.g., HPLMN or VPLMN, of the first USIM of the UE 100. In addition, the NG-RAN 300b and the AMF 410b may belong to the second PLMN, e.g., HPLMN or VPLMN, of the second USIM of the UE 100.

In FIG. 9, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different. An operation for the UE 100 to register to each PLMN and an operation for the UE 100 to create a PDU session will be referred to in FIGS. 5 and 6.

1) The UE 100 is receiving a service using the first USIM. That is, active communication exists in the first PLMN to which the UE 100 registered based on the first USIM. For example, the UE 100 may be downloading a sound source using the application #1 in the first PLMN registered based on the first USIM.

2) A Mobile Terminating (MT) service for the second USIM of the UE 100 occurs. Since the UE 100 is in an idle state in the second PLMN registered based on the second USIM, the AMF 410b transmits a paging message. For example, the AMF 410b may transmit a paging message to the NG-RAN 300b of the second PLMN. The MT service may include both MT data (or MT user traffic) and MT signals.

3) The NG-RAN 300b of the second PLMN receiving the paging message from the AMF 410b transmits the paging message to the UE 100.

4) The UE 100 determines to respond to the received paging message. This determination may be performed according to, e.g., an input/selection provided by a user based on information in the paging message received from the second PLMN registered based on the second USIM (e.g., information on which MT service has occurred, which may include at least one of voice calls, video calls, SMS, other data service, etc.) or an input/selection based on UE preference/policy (priority) setting. However, this is only an example, and the response to the received paging message is not limited thereto, and may be determined based on various/complex inputs.

According to the above determination (i.e., determination to respond to the paging message related to the MT service occurred for the second USIM), the UE 100 transmits a request message, e.g., a Service Suspend Request message, for suspending active communication to the AMF 410a of the first PLMN. The Service Suspend Request message is transmitted to the AMF 410a via the NG-RAN 300a of the first PLMN.

The Service Suspend Request message may include one or more of the following information. The information below may be included, either implicitly or in combination.

i) PDU session ID: If there are multiple active communications that need to be suspended and multiple PDU sessions are used, corresponding all PDU session IDs are included.

ii) Information requesting to suspend active communication

iii) Information requesting AN release (or transition to idle mode)

The UE 100 may include one or more of the following information for each PDU session in the Service Suspend Request message. By including this information in a transparent form to the AMF 410a, the AMF 410a does not interpret it, and may be transmitted by being included in the message of step 6 which is to be transmitted to the SMF 420a managing/serving the corresponding PDU session.

a) QFI(s) information: This may be interpreted as information on the QoS flow used for active communication to be suspended.

b) Packet filter-related information: This may be interpreted as packet filter-related information (in part or all) that can represent active communication to be suspended.

c) URSP-related information: This may be interpreted as URSP-related information (in part or all) that can represent active communication to be suspended.

d) Service-related information: This may be in the form of, e.g., a voice service, a video service, SMS, USSD, etc., and may be expressed in various granularities. This may be application information.

A new MM NAS message called the Service Suspend Request may be defined and used, or an existing MM NAS message may be extended and used as a request message for suspending active communication.

The UE 100 may store information on active communication that has been suspended (or requested to be suspended).

5) NG-RAN 300a transmits the NAS message received from the UE 100 to the AMF 410a.

6) The AMF 410a transmits a Service Suspend Request message to the SMF 420a managing/serving the PDU session requested to be suspended based on the Service Suspend Request message received from the UE 100. In this case, an existing or newly defined Nsmf service operation may be used to transmit the message to the SMF 420a. Here, the newly defined Nsmf service operation may be an operation related to suspension of active communication.

When the UE 100 includes a plurality of PDU sessions in step 4, the AMF 410a performs step 6 with the SMF 420a managing/serving each PDU session.

7) The SMF 420a requests/instructs the UPF 440a to suspend active communication. In this case, the existing N4 message may be extended and used for requesting/instructing suspension of active communication, or a new N4 message may be defined and used for requesting/instructing suspension of active communication. By requesting/instructing the UPF 440a to suspend active communication, the UPF 440a no longer transmits/forwards traffic corresponding to the suspended active communication. The traffic may be downlink traffic and/or uplink traffic. And, even if downlink traffic corresponding to the suspended active communication occurs (i.e., even if the UPF 440a receives downlink traffic corresponding to the suspended active communication), the UPF 440a does not transmit Data Notification to the SMF 420a. In addition to not transmitting/forwarding traffic anymore, the traffic may be dropped or buffered. The buffering may be performed only for a preset time.

The UPF 440a may suspend, based on the ongoing traffic for the UE 100, i.e., by detecting the ongoing traffic, active communication for the ongoing traffic. Or, the UPF 440a may suspend all services/traffic for the UE 100. Or, the UPF 440a may suspend the PDU session itself of the UE 100.

When the SMF 420a receives from the UE 100 via the AMF 410a one or more of ‘a) QFI(s) information’, ‘b) packet filter-related information’, ‘c) URSP-related information’, and ‘d) service-related information’ described in step 4 above, the SMF 420a may provide the information by transforming it into an information form that the UPF 440a can understand. That is, the UPF 440a may suspend active communication based on the information provided by the SMF 420a.

For example, when the UPF 440a receives ‘a) QFI(s) information’, it may be interpreted as suspending a QoS flow related to active communication. When the UPF 440a receives ‘b) packet filter-related information’, it may be interpreted as suspending a packet corresponding to a packet filter related to active communication. When the UPF 440a receives ‘c) the URSP-related information’, it may be understood as suspending the packet indicated by the URSP related to active communication.

The UE 100 and/or the SMF 420a may cause the UPF 440a, based on the ongoing traffic for the UE 100, i.e., by detecting the ongoing traffic, to suspend active communication for the ongoing traffic. Or, the UE 100 and/or the SMF 420a may cause the UPF 440a to suspend all services/traffic for the UE 100. Or, the UE 100 and/or the SMF 420a may cause the UPF 440a to suspend the PDU session itself of the UE 100. For example, by not providing the UPF 440a with information a) to d) of step 4 above or information derived therefrom, or by instructing the UPF 440a to operate as described above, the UE 100 and/or the SMF 420a may cause UPF 440a to adjust suspension target (e.g., active communication for ongoing traffic for the UE 100, all services/traffics for the UE 100 or PDU session itself).

In the above, the SMF 420a may perform an operation of deactivating the user plane (N3) after requesting suspension from the UPF 440a, or the suspension operation may be performed as part of the operation of deactivating the user plane (N3).

8) The UPF 440a transmits a response to the Service Suspend Request to the SMF 420a.

Although not shown, the SMF 420a may transmit a response to the Service Suspend Request to the AMF 410a. In addition, the SMF 420a may transmit a response to the Service Suspend Request to the UE 100.

9) The AMF 410a performs an Access Network (AN) release procedure.

Step 9 may be performed immediately after step 6, or may be performed in parallel with step 6. Or, if the SMF 420a gives a response to a Service Suspension Request, step 9 may be performed after receiving it.

10-11) These steps are similar to the steps 12-13 of FIG. 8.

If the paging message is received as in step 3, but the UE 100 is in a connected state without active communication in the PLMN registered through the first USIM, the UE 100 may transmit the Service Suspend Request message only including the information iii) in step 4.

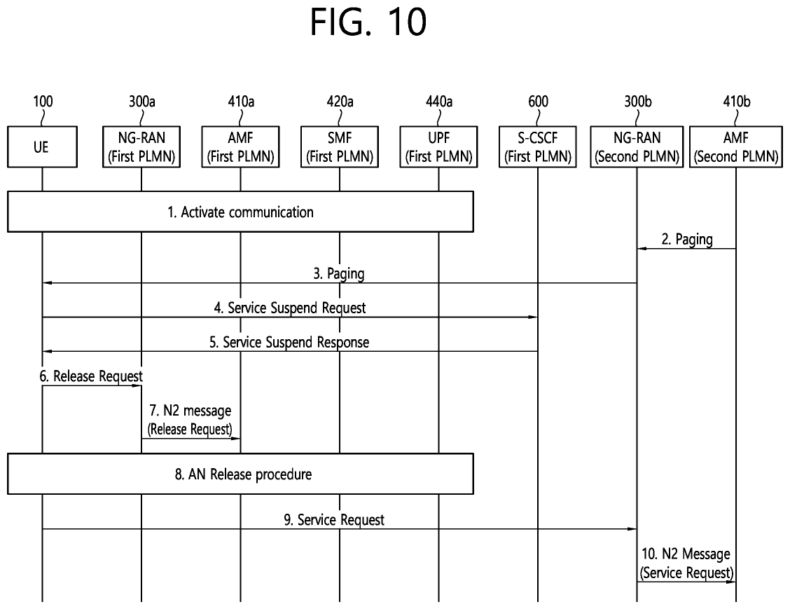

FIG. 10 is an exemplary diagram illustrating an operation according to a third example of the first disclosure of the present specification.

FIG. 10 shows a scheme for suspending active communication using an IMS message. This can be applied to the IMS service.

In FIG. 10, the NG-RAN 300a, AMF 410a, SMF 420a, and UPF 440a may belong to the first PLMN, e.g., HPLMN or VPLMN, registered based on the first USIM of the UE 100.

In addition, the NG-RAN 300b and the AMF 410b may belong to the second PLMN, e.g., HPLMN or VPLMN, registered based on the second USIM of the UE 100.

And, the S-CSCF 600 is the S-CSCF of the IMS network belonging the first PLMN, i.e., HPLMN, registered based on the first USIM of the UE 100.

In FIG. 10, only the S-CSCF is shown for the IMS network for convenience.

In FIG. 10, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different.

An operation for the UE 100 to register to each PLMN and an operation for the UE 100 to create a PDU session will be referred to in FIGS. 5 and 6.

1) The UE 100 is receiving an IMS service using the first USIM. That is, active communication (e.g., voice call) exists in the first PLMN registered based on the first USIM.

2) A MT service for the second USIM of the UE 100 occurs. Since the UE 100 is in an idle state in the second PLMN registered based on the second USIM, the AMF 410b of the second PLMN transmits a paging message. For example, the AMF 410b may transmit a paging message to the NG-RAN 300b of the second PLMN. The MT service may include both MT data (or MT user traffic) and MT signals.

3) The NG-RAN 300b of the second PLMN receiving the paging message from the AMF 410b transmits the paging message to the UE 100.

4) The UE 100 determines to respond to the received paging message. This determination may be performed according to, e.g., an input/selection provided by a user based on information in the paging message received from the second PLMN registered based on the second USIM (e.g., information on which MT service has occurred, which may include at least one of voice calls, video calls, SMS, other data service, etc.) or an input/selection based on UE preference/priority setting.

However, this is only an example, and the response to the received paging message is not limited thereto, and may be determined based on various/complex inputs.

According to the above determination (determination to respond to the paging message related to the MT service occurred for the second USIM), the UE 100 transmits a request message, e.g., a Service Suspend Request message, for suspending/holding active communication to the S-CSCF 600. The Service Suspend Request message is an IMS message (i.e., an IMS signal or a SIP signal). The IMS message may be used to suspend/hold active communication as it is or by extending the existing Session Initiation Protocol (SIP)-based method, or a new SIP method may be defined and used.

The Service Suspend Request message may include one or more of the following information. The information below may be included, either implicitly or in combination. In addition, the following information may be included in the SIP part and/or the SDP part.

i) Service-related information: This may be in the form of, e.g., a voice service, a video service, SMS, USSD (or USSI), etc., and may be expressed in various granularities.

ii) IMS session related information: Various information that can represent IMS session. For example, information such as Request-URI, From, To, and Call-ID of the IMS session.

iii) Media-related information: information such as voice/audio, video, etc.

iv) Information requesting to suspend/hold active communication

If the active communication to be suspended/held is IMS session-based communication (this may be interpreted as maintaining an IMS session with the counterpart UE using a SIP-based INVITE message, e.g., voice call, video call, etc.), an existing session hold mechanism/procedure may be used. That is, the operation of stopping/deactivating the media flow may be performed using the SIP-based UPDATE message.

As described above, when the UE 100 determines to respond to the paging message received from the second PLMN registered through the second USIM, the user may take an operation for holding the session. Alternatively, it may be determined that the UE 100 responds to the paging message by taking an operation for holding a session for the service received from the first PLMN registered by the user through the first USIM. In this case, by the user's input, the UE 100 transmits a request for holding the session to the IMS network.

Upon receiving the Service Suspend Request message from the UE 100, the S-CSCF 600 performs an operation of suspending/holding active communication. This may involve interaction with the counterpart of the IMS session (e.g., in the case of a voice call, holding the session with the counterpart UE).

Instead of or together with the S-CSCF, another IMS entity (e.g., an application server) may perform an operation of suspending/holding the active communication.

The UE 100 may store information on active communication that has been suspended/held or requested to be suspended/held.

5) S-CSCF 600 transmits a response to the Service Suspend Request to the UE 100.

The response message to the Service Suspend Request is an IMS message (i.e., an IMS signal or a SIP signal). The IMS message may be used as a response to a Service Suspend Request by using an existing IMS message as it is or by extending it, or a new IMS message may be defined and used. For example, 200 OK may be used as a response to a Service Suspend Request.

6-7) The UE 100 transmits to the AMF 410a a NAS message, e.g., a Release Request message, requesting to switch to the idle mode for the first PLMN registered based on the first USIM. This NAS message is transmitted to the AMF 410a via the NG-RAN 300a. A new Mobility Management (MM) NAS message called the Release Request message may be defined and used, or an existing MM NAS message may be extended and used.

Although the figure shows that the Release Request message is transmitted after step 5, this is only an example. The UE 100 may transmit the Release Request message immediately after step 4.

Instead of requesting to switch to the idle mode for the first PLMN registered based on the first USIM from the AMF 410a using the NAS message, the UE 100 may request this from the NG-RAN 300a. For requesting to the idle mode, an existing RRC message may be extended and used as a request to switch to the idle mode for the first PLMN registered based on the first USIM, or a new RRC message may be defined and used. Upon receiving the request to switch to the idle mode from the UE 100, the NG-RAN 300a performs an AN release procedure. In this case, it can be understood that the NG-RAN 300a performs the AN release procedure instead of the AMF 410a performing the AN release procedure described in step 8.

8) The AMF 410a performs an Access Network (AN) release procedure.

The AN release procedure may be initiated by the NG-RAN 300a due to inactivity (i.e., user inactivity) according to the UE 100 suspending active communication without requesting the network to switch to the idle mode as described above. For example, the UE 100 may naturally go to the idle mode, or may be intentionally made to go to the idle mode after suspension. However, after waiting until the deactivation timer expires in the NG-RAN 300a, the NG-RAN 300a performs the AN release procedure.

9-10) These steps are the same as steps 12-13 of FIG. 8.

If the paging message is received as in step 3, but the UE 100 is in the connected mode without active communication in the first PLMN registered through the first USIM, the UE 100 performs from step 6. That is, if the UE 100 is in the connected state without active communication in the first PLMN registered through the first USIM, the UE 100 may skip steps 4 to 5 without performing.

### II. Second Disclosure: A Method for Resuming Suspended Active Communication

If there is active communication suspended in the first PLMN registered based on the first USIM, when the service is terminated in the second PLMN registered based on the second USIM, or the UE 100 becomes the idle state in the second PLMN registered based on the second USIM, or by a user input, the UE 100 may resume the suspended communication in the first PLMN. How to resume by which condition may be set in the UE. The setting may be made by a user, may be configured from a network, or may be an internal setting of the UE 100.

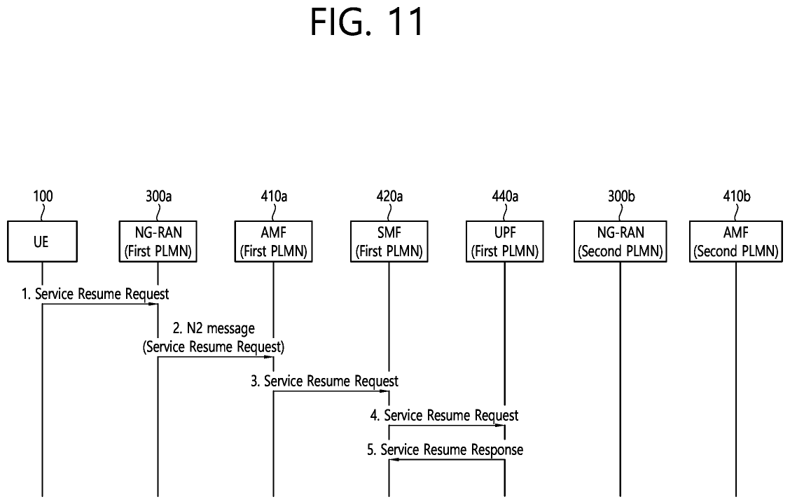

FIG. 11 is an exemplary diagram illustrating an operation according to a first example of the second disclosure of the present specification.

FIG. 11 shows a method of resuming suspended communication using a Session Management (SM) NAS message. This can be applied to both non-IMS services and IMS services.

In FIG. 11, the NG-RAN 300a, AMF 410a, SMF 420a, and UPF 440a may belong to the first PLMN, e.g., HPLMN or VPLMN, registered based on the first USIM of the UE 100.

In addition, the NG-RAN 300b and the AMF 410b may belong to the second PLMN, e.g., HPLMN or VPLMN, registered based on the second USIM.

In FIG. 11, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different. An operation for the UE 100 to register to each PLMN and an operation for the UE 100 to create a PDU session will be referred to in FIGS. 5 and 6.

1) After receiving a service from the second PLMN registered based on the second USIM while in a state in which active communication is suspended in the first PLMN registered based on the first USIM, the UE 100 again wants to receive service from the first PLMN registered based on the first USIM.

Accordingly, the UE 100 transmits a request message, e.g., Service Resume Request message, for resuming communication suspended in the first PLMN to the SMF 420a. The Service Resume Request message is transmitted to the SMF 420a through the NG-RAN 300a through the AMF 410a. It is assumed that the UE 100 enters a connected state in the first PLMN to transmit the request message.

The UE 100 resumes all suspended active communications, and transmits the Service Resume Request message to the related SMF 420a for all PDU sessions related thereto. Alternatively, the UE 100 may resume only some of the communication, not all active communication that was suspended.

The Service Resume Request message may include one or more of the following information. The information below may be included, either implicitly or in combination.

i) PDU session ID

ii) QFI(s) information: This may be interpreted as information on the QoS flow used for communication to be resumed.

iii) Packet filter-related information: This may be interpreted as packet filter-related information (in part or all) that can represent communication to be resumed.

iv) URSP-related information: This may be interpreted as URSP-related information (in part or all) that can represent communication to be resumed.

v) Service-related information: This may be in the form of, e.g., a voice service, a video service, SMS, USSD, etc., and may be expressed in various granularities. This may be application information.

vi) Request information to resume suspended communication

A new Session Management (SM) NAS message called the Service Resume Request message may be defined and used, or the existing SM NAS message may be extended and used as a request message for resuming suspended active communication.

In addition, as the Service Resume Request message is transmitted to the SMF 420a through the AMF 410a, the UE 100 includes the information necessary for the AMF 410a to process the SM NAS message by including the PDU session ID in the NAS message including the Service Resume Request message. For example, the UE 100 may include the N1 SM container corresponding to the Service Resume Request message in the NAS message as follows.

The NAS message may include a PDU session ID and an N1 SM container. The N1 SM container may include a Service Resume Request message.

2) The NG-RAN 300a transmits the NAS message received from the UE 100 to the AMF 410a.

3) The AMF 410a transmits the Service Resume Request message to the SMF 420a. In this case, an existing or newly defined Nsmf service operation may be used to transmit the message to the SMF 420a. Here, the newly defined Nsmf service operation may be an operation related to resumption of suspended communication.

4) The SMF 420a requests/instructs the resumption of communication that has been suspended to the UPF 440a. At this time, the existing N4 message may be extended and used to request/instruct the resumption of the suspended communication, or a new N4 message may be defined and used to request/instruct the resumption of the suspended communication.

Upon requesting/instructing the resumption to the UPF 440a, the UPF 440a releases the suspend operation. That is, when traffic occurs or is received for the resumed communication, it is normally processed.

Upon request from the UPF 440a, the SMF 420a may provide the information received from the UE 100 to the UPF 440a as it is, or may transform the information received from the UE 100 and provide it to the UPF 440a. When the SMF 420a receives from the UE 100 one or more of ‘ii) QFI(s) information’, ‘iii) packet filter-related information’, ‘iv) URSP-related information’, and ‘v) service-related information’ described in step 1 above, the SMF 420a may provide the information by transforming it into an information form that the UPF 440a can understand. That is, the UPF 440a may perform the resume operation based on the information provided by the SMF 420a.

For example, when the UPF 440a receives ‘ii) QFI(s) information’, it may be interpreted as resuming a QoS flow related to the suspended communication. When the UPF 440a receives ‘iii) packet filter-related information’, it may be interpreted as resuming a packet corresponding to a packet filter related to the suspended communication. When the UPF 440a receives ‘iv) the URSP-related information’, it may be understood as resuming the packet indicated by the URSP related to the suspended communication.

The UE and/or the SMF 420a may cause the UPF 440a to resume all communications/traffics that has been suspended for the UE 100, or the UE 100 and/or the SMF 420a may cause the UPF 440a to resume the PDU session itself of the UE 100. For example, by not providing the UPF 440a with information ii) to v) of step 1 above or information derived therefrom, or by instructing the UPF 440a to operate as described above, the UE 100 and/or the SMF 420a may cause UPF 440a to adjust resumption target (e.g., all services/traffics that has been suspended for the UE 100 or PDU session itself).

In the above, the SMF 420a may perform an operation of activating the user plane (N3) after requesting resumption from the UPF 440a, or the resumption operation may be performed as part of the operation of activating the user plane (N3).

8) The UPF 440a transmits a response to the Service Resume Request to the SMF 420a.

Although not shown, the SMF 420a may transmit a response to the Service Resume Request to the AMF 410a. In addition, the SMF 420a may transmit a response to the Service Resume Request to the UE 100.

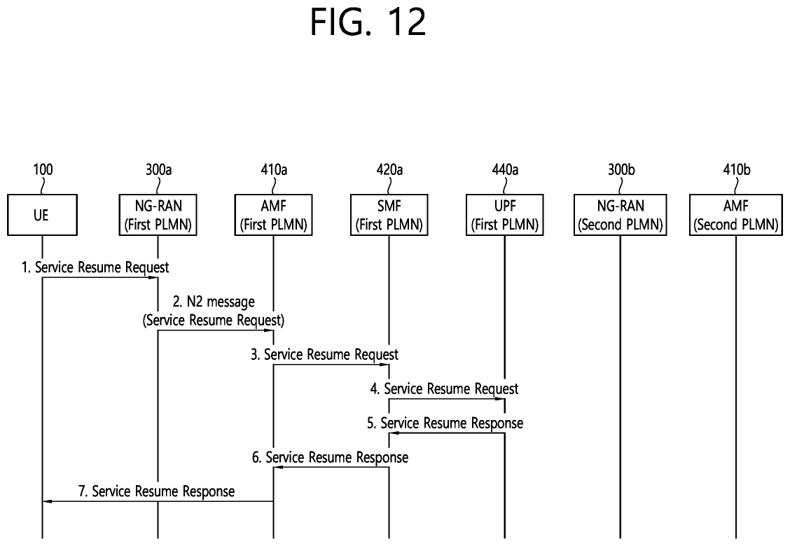

FIG. 12 is an exemplary diagram illustrating an operation according to a second example of the second disclosure of the present specification.

FIG. 12 shows a method of resuming suspended communication using a Mobility Management (MM) NAS message. This can be applied to both non-IMS services and IMS services.

In FIG. 12, the NG-RAN 300a, AMF 410a, SMF 420a, and UPF 440a may belong to the first PLMN, e.g., HPLMN or VPLMN, registered based on the first USIM of the UE 100.

In addition, the NG-RAN 300b and the AMF 410b may belong to the second PLMN, e.g., HPLMN or VPLMN, registered based on the second USIM.

In FIG. 12, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different. An operation for the UE 100 to register to each PLMN and an operation for the UE 100 to create a PDU session will be referred to in FIGS. 5 and 6.

1) After receiving a service from the second PLMN registered based on the second USIM while in a state in which active communication is suspended in the first PLMN registered based on the first USIM, the UE 100 again wants to receive service from the first PLMN.

Accordingly, the UE 100 transmits to the AMF 410a a request message, e.g., Service Resume Request message, for resuming communication suspended in the first PLMN registered based on the first USIM. The Service Resume Request message is transmitted to the AMF 410a through the NG-RAN 300a.

The UE 100 may resume all suspended active communications.

The Service Resume Request message may include one or more of the following information. The information below may be included, either implicitly or in combination.

i) PDU session ID

ii) Request information to resume suspended communication

iii) Information to activate the user plane of the PDU session

The UE 100 may additionally include one or more of the following information for each PDU session to the Service Resume Request message. By including this information in a transparent form to the AMF 410a, the AMF 410a does not interpret it, and may be transmitted by being included in the message of step 3 which is to be transmitted to the SMF 420a managing/serving the corresponding PDU session.

a) QFI(s) information: This may be interpreted as information on the QoS flow used for communication to be resumed.

b) Packet filter-related information: This may be interpreted as packet filter-related information (in part or all) that can represent communication to be resumed.

c) URSP-related information: This may be interpreted as URSP-related information (in part or all) that can represent communication to be resumed.

d) Service-related information: This may be in the form of, e.g., a voice service, a video service, SMS, USSD, etc., and may be expressed in various granularities. This may be application information.

A new MM NAS message called the Service Resume Request message may be defined and used, or the existing MM NAS message may be extended and used as a request message for resuming suspended active communication.

A service request message or a registration request message may be used for the request, in which case one or more information of i) to iii) may be included, or by activating the user plane of the PDU session using the existing List Of PDU sessions To Be Activated, the effect of resumption may be caused. Alternatively, the resumption may be requested by using one or more information of i) to iii) and an existing parameter such as the existing List Of PDU sessions To Be Activated.

2) The NG-RAN 300a transmits the NAS message received from the UE 100 to the AMF 410a.

3) The AMF 410a transmits a Service Resume Request message to the SMF 420a managing/serving the PDU session requested to be resumed based on the Service Resume Request message received from the UE 100. In this case, an existing or newly defined Nsmf service operation may be used to transmit the message to the SMF 420a. Here, the newly defined Nsmf service operation may be an operation related to resumption of suspended communication.

When the UE 100 includes a plurality of PDU sessions in step 1, the AMF 410a performs step 3 with the SMF managing/serving each PDU session.

4) The SMF 420a requests/instructs the resumption of communication that has been suspended to the UPF 440a. At this time, the existing N4 message may be extended and used to request/instruct the resumption of the suspended communication, or a new N4 message may be defined and used to request/instruct the resumption of the suspended communication. Upon requesting/instructing the resumption to the UPF 440a, the UPF 440a releases the suspend operation. That is, when traffic occurs or is received for the resumed communication, it is normally processed.

The UPF 440a may resume all communication/traffic that has been suspended for the UE 100, or may resume the PDU session itself of the UE 100.

When the SMF 420a receives from the UE 100 via the AMF 410a one or more of ‘a) QFI(s) information’, ‘b) packet filter-related information’, ‘c) URSP-related information’, and ‘d) service-related information’ described in step 1 above, the SMF 420a may provide the information by transforming it into an information form that the UPF 440a can understand. That is, the UPF 440a may perform the resume operation based on the information provided by the SMF 420a.

For example, when the UPF 440a receives ‘a) QFI(s) information’, it may be interpreted as resuming a QoS flow related to the suspended communication. When the UPF 440a receives ‘b) packet filter-related information’, it may be interpreted as resuming a packet corresponding to a packet filter related to the suspended communication. When the UPF 440a receives ‘c) the URSP-related information’, it may be understood as resuming the packet indicated by the URSP related to the suspended communication.

The UE and/or the SMF 420a may cause the UPF 440a to resume all communications/traffics that has been suspended for the UE 100, or the UE 100 and/or the SMF 420a may cause the UPF 440a to resume the PDU session itself of the UE 100. For example, by not providing the UPF 440a with information a) to d) of step 1 above or information derived therefrom, or by instructing the UPF 440a to operate as described above, the UE 100 and/or the SMF 420a may cause UPF 440a to adjust resumption target (e.g., all services/traffics that has been suspended for the UE 100 or PDU session itself).

In the above, the SMF 420a may perform an operation of activating the user plane (N3) after requesting resumption from the UPF 440a, or the resumption operation may be performed as part of the operation of activating the user plane (N3).

5) The UPF 440a transmits a response to the Service Resume Request message to the SMF 420a.

6) The SMF 420a transmits a response to the Service Resume Request message to the AMF 410a.

7) The AMF 410a transmits a response to the Service Resume Request message to the UE 100.

As the UE 100 switches to the connected state in the first PLMN registered based on the first USIM (e.g., through a registration procedure, a service request procedure, etc.), the SMF 420a serving the PDU session with previously suspended communication may resume to the UPF 440a. To this end, it is necessary for the SMF 420a to store information about the suspended communication. In addition, it is necessary for the SMF 420a to be aware that the UE 100 transitions from the idle state to the connected state. To this end, after suspension, the SMF 420a may request from the AMF 410a to notify when the UE 100 switches from the idle state to the connected state.

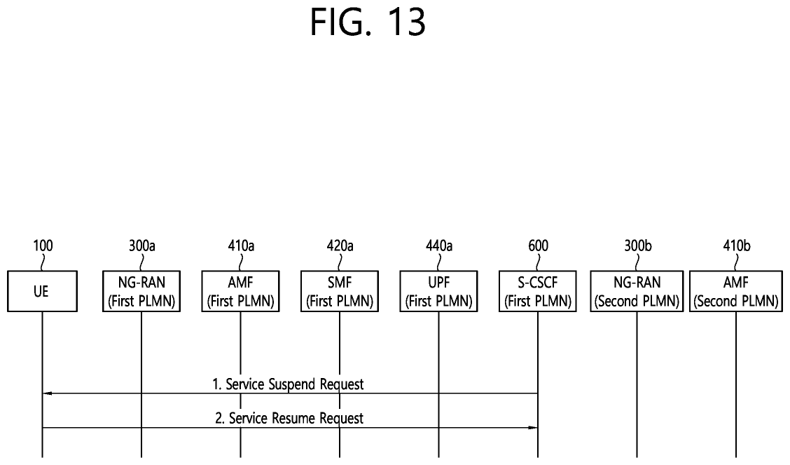

FIG. 13 is an exemplary diagram illustrating an operation according to a third example of the second disclosure of the present specification.

FIG. 13 shows a scheme for resuming the suspended communication using an IMS message. This can be applied to the IMS service.

In FIG. 13, the NG-RAN 300a, AMF 410a, SMF 420a, and UPF 440a may belong to the first PLMN, e.g., HPLMN or VPLMN, registered based on the first USIM of the UE 100.

In addition, the NG-RAN 300b and the AMF 410b may belong to the second PLMN, e.g., HPLMN or VPLMN, registered based on the second USIM.

And, the S-CSCF 600 is the S-CSCF of the IMS network belonging the first PLMN, i.e., HPLMN, registered based on the first USIM of the UE 100.

In FIG. 13, only the S-CSCF is shown for the IMS network for convenience.

In FIG. 13, it is assumed that the UE 100 is in a state in which a necessary PDU session has been created by registering to each PLMN using the first USIM and the second USIM, respectively. In this case, the first PLMN registered based on the first USIM and the second PLMN registered based on the second USIM may be the same or different.

An operation for the UE 100 to register to each PLMN and an operation for the UE 100 to create a PDU session will be referred to in FIGS. 5 and 6.

1) After receiving the service from the second PLMN while in a state in which active communication is suspended in the first PLMN, the UE 100 wants to receive the service from the first PLMN again. In particular, the suspended communication is for an IMS service.

Accordingly, the UE 100 transmits a request message, e.g., Service Resume Request message, for resuming the suspended active communication to the IMS network. The Service Resume Request message is an IMS message (i.e., an IMS signal or a SIP signal). The IMS message may be used for resuming suspended active communication as it is or by extension of the existing SIP-based method, or a new SIP-based method may be defined and used for resuming suspended active communication. It is assumed that the UE 100 enters a connected state in the first PLMN registered based on the first USIM in order to transmit the request message.

The UE 100 may resume for all active communications that have been suspended, or may resume only some of the communications that have been suspended.

The Service Resume Request message may include one or more of the following information. The information below may be included, either implicitly or in combination. In addition, the following information may be included in the SIP part and/or the SDP part.

i) Service-related information: This may be in the form of, e.g., a voice service, a video service, SMS, USSD (or USSI), etc., and may be expressed in various granularities.

ii) IMS session related information: Various information that can represent IMS session. For example, information such as Request-URI, From, To, and Call-ID of the IMS session.

iii) Media-related information: information such as voice/audio, video, etc.

iv) Information requesting to resume suspended communication

If the communication to be resumed is IMS session-based communication (this may be interpreted as maintaining an IMS session with the other UE using SIP-based INVITE, e.g., voice call, video call, etc.), an existing session resumption mechanism/procedure may be used for resuming the suspended active communication. That is, it is an operation to resume/restore the media flow using SIP UPDATE. For detailed operations, refer to Section 10.1 of TS 24.228 (Session hold and resume procedures).

As described above, when the UE 100 determines to receive a service from the PLMN registered through the first USIM, the user may take a session resumption operation. Alternatively, it may be determined that the UE 100 receives a service from the PLMN registered through the first USIM by the user taking a resume operation for the suspended session in the first USIM. In this case, the UE 100 transmits a session resumption request to the IMS network by the user's input.

Upon receiving the Service Resume Request message from the UE 100, the S-CSCF 600 performs an operation of resuming the suspended communication. This may involve interaction with the counterpart of the IMS session (e.g., in the case of a voice call, resuming the session to the counterpart UE making a voice call with the UE).

Instead of or together with the S-CSCF, another IMS entity (e.g., an application server) may perform the operation of resuming the communication.

2) The S-CSCF 600 transmits a response to the Service Resume Request message to the UE 100.

The response message to the Service Resume Request message is an IMS message (i.e., an IMS signal or a SIP signal). The IMS message may be used for the purpose of a response to the Service Resume Request message by using an existing IMS message as it is or by extending it, or a new IMS message may be defined and used the purpose of a response to the Service Resume Request message. For example, 200 OK may be used the purpose of a response to a Service Resume Request message.

In the above, 5GS was mainly described. However, this can also be applied to EPS. In this case, it may be applied that the NG-RAN may be replaced with to the eNB, the NAS message transmitted to the AMF or SMF may be replaced with the NAS message transmitted to the MME, and the operation of the UPF may be replaced with the operation of the GW.

The UE 100 may include information notifying that it is a multi-USIM UE or performs an operation for multi-USIM when registering with 5GS and/or registering with an IMS network. The information may be included in subscriber information.

In the above description, the operation is mainly based on two USIMs, but this can of course be applied to a UE having three or more USIMs.

According to the disclosures of the present specification described above, in case that it is provided/notified from the network that the MT service has occurred for the second USIM while in the state in which the UE 100 is receiving the service for the first USIM (which may be interpreted as a connected state), communication activated through the first USIM may be suspended. And, the suspended communication may be resumed.

Hereinafter, an apparatus to which the above disclosure of the present specification can be applied will be described.

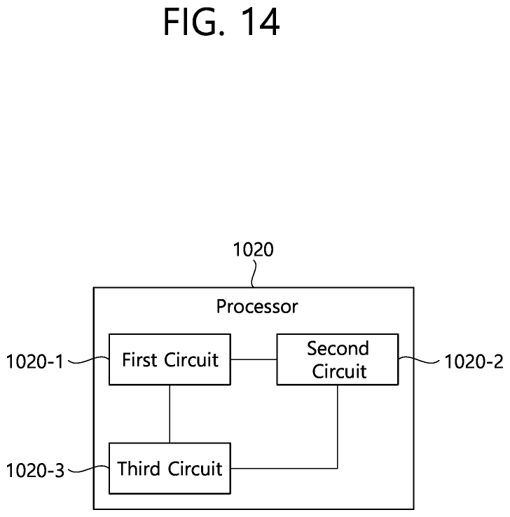

FIG. 14 shows a block diagram of a processor in which the disclosure of the present specification is implemented.

As can be seen with reference to FIG. 14, a processor 1020 in which the disclosure of the present specification is implemented may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an Application-Specific Integrated Circuit (ASIC) or an Application Processor (AP), and may include at least one of a Digital Signal Processor (DSP), a Central Processing Unit (CPU), and a Graphics Processing Unit (GPU).

The processor may be included in the AMF.

The first circuit 1020-1 of the processor supports multiple Universal Subscriber Identity Modules (USIMs) and may receive a first request message from a UE that has received a paging message from a second network.

The first request message may include information on one or more Protocol Data Unit (PDU) sessions and information on release.

The second circuit 1020-2 of the processor may transmit a second message to a Session Management Function (SMF) device in the first network.

The second message may include information on the one or more PDU sessions based on the first request message.

The third circuit 1020-3 of the processor may perform a procedure for releasing with a Radio Access Network (RAN) in the first network.

A fourth circuit (not shown) of the processor may determine an SMF device managing or serving each PDU session based on the information on the one or more PDU sessions included in the request message received from the UE.

When there is a plurality of the determined SMF devices, the second message may be transmitted to the determined plurality of SMF devices.

The second message may be used by the SMF device to request a User Plane Function (UPF) device to delete downlink data.

The second message may be used by the SMF device to request a User Plane Function (UPF) device to no longer transmit downlink data.

Based on the first request message and the second message, the one or more PDU sessions may be suspended.

A fifth circuit (not shown) of the processor may receive a second request message from the UE.

Based on the reception of the second request message, a sixth circuit (not shown) of the processor may transmit a third message to the SMF device.

The third message may be used to enable the SMF device to transmit a paging message for downlink data.

A seventh circuit (not shown) of the processor may transmit an accept message for the second request message to the UE.

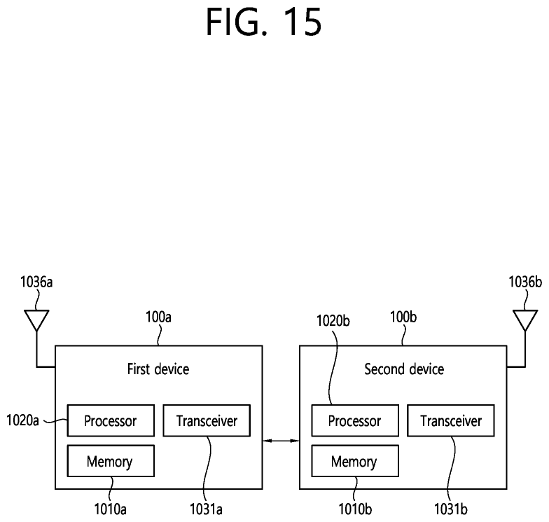

FIG. 15 illustrates a wireless communication system according to an embodiment.

Referring to FIG. 15, the wireless communication system may include a first device 100a and a second device 100b.

The first device 100a may be a UE described in the disclosure of the present specification. Or, the first device 100a may be a base station, a network node, a transmission terminal, a reception terminal, a wireless device, a wireless communication device, a vehicle, a vehicle on which a self-driving function is mounted, a connected car, a drone (Unmanned Aerial Vehicle (UAV)), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a FinTech device (or financial device), a security device, a climate/environment device, a device related to 5G service or a device related to the fourth industrial revolution field.

The second device 100b may be a network node (e.g., AMF or MME) described in the disclosure of the present specification. Or, the second device 100b may be a base station, a network node, a transmission terminal, a reception terminal, a wireless device, a wireless communication device, a vehicle, a vehicle on which a self-driving function is mounted, a connected car, a drone (Unmanned Aerial Vehicle (UAV)), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a FinTech device (or financial device), a security device, a climate/environment device, a device related to 5G service or a device related to the fourth industrial revolution field.

For example, the UE may include a cellular phone, a smart phone, a laptop computer, a terminal for digital broadcasting, a Personal Digital Assistants (PDA), a Portable Multimedia Player (PMP), a navigation, a slate PC, a tablet PC, an ultrabook, a wearable device (e.g., a watch type terminal (smartwatch), a glass type terminal (smart glass), a Head Mounted Display (HMD)), and so on. For example, the HMD may be a display device of a form, which is worn on the head. For example, the HMD may be used to implement VR, AR or MR.

For example, the drone may be a flight vehicle that flies by a wireless control signal without a person being on the flight vehicle. For example, the VR device may include a device implementing the object or background of a virtual world. For example, the AR device may include a device implementing the object or background of a virtual world by connecting it to the object or background of the real world. For example, the MR device may include a device implementing the object or background of a virtual world by merging it with the object or background of the real world. For example, the hologram device may include a device implementing a 360-degree stereographic image by recording and playing back stereographic information using the interference phenomenon of a light beam generated when two lasers called holography are met. For example, the public safety device may include a video relay device or an imaging device capable of being worn on a user's body. For example, the MTC device and the IoT device may be a device that does not require a person's direct intervention or manipulation. For example, the MTC device and the IoT device may include a smart meter, a vending machine, a thermometer, a smart bulb, a door lock or a variety of sensors. For example, the medical device may be a device used for the purpose of diagnosing, treating, reducing, handling or preventing a disease. For example, the medical device may be a device used for the purpose of diagnosing, treating, reducing or correcting an injury or obstacle. For example, the medical device may be a device used for the purpose of testing, substituting or modifying a structure or function. For example, the medical device may be a device used for the purpose of controlling pregnancy. For example, the medical device may include a device for medical treatment, a device for operation, a device for (external) diagnosis, a hearing aid or a device for a surgical procedure. For example, the security device may be a device installed to prevent a possible danger and to maintain safety. For example, the security device may be a camera, CCTV, a recorder or a blackbox. For example, the FinTech device may be a device capable of providing financial services, such as mobile payment. For example, the FinTech device may include a payment device or Point of Sales (PoS). For example, the climate/environment device may include a device for monitoring or predicting the climate/environment.

The first device 100a may include at least one processor such as a processor 1020a, at least one memory such as memory 1010a, and at least one transceiver such as a transceiver 1031a. The processor 1020a may perform the above-described functions, procedures, and/or methods. The processor 1020a may perform one or more protocols. For example, the processor 1020a may perform one or more layers of a radio interface protocol. The memory 1010a is connected to the processor 1020a, and may store various forms of information and/or instructions. The transceiver 1031a is connected to the processor 1020a, and may be controlled to transmit and receive radio signals.

The second device 100b may include at least one processor such as a processor 1020b, at least one memory device such as memory 1010b, and at least one transceiver such as a transceiver 1031b. The processor 1020b may perform the above-described functions, procedures and/or methods. The processor 1020b may implement one or more protocols. For example, the processor 1020b may implement one or more layers of a radio interface protocol. The memory 1010b is connected to the processor 1020b, and may store various forms of information and/or instructions. The transceiver 1031b is connected to the processor 1020b and may be controlled transmit and receive radio signals.

The memory 1010a and/or the memory 1010b may be connected inside or outside the processor 1020a and/or the processor 1020b, respectively, and may be connected to another processor through various technologies, such as a wired or wireless connection.

The first device 100a and/or the second device 100b may have one or more antennas. For example, an antenna 1036a and/or an antenna 1036b may be configured to transmit and receive radio signals.

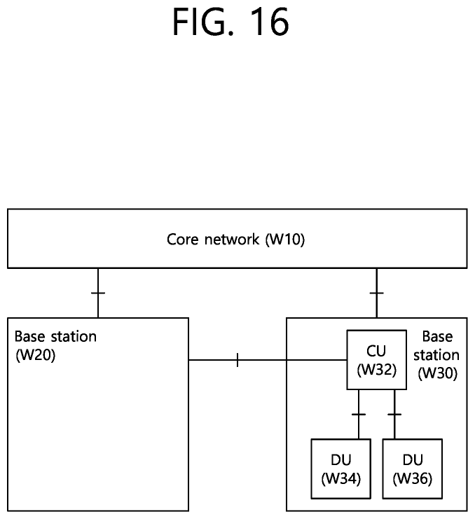

FIG. 16 illustrates a block diagram of a network node according to an embodiment.

In particular, FIG. 16 is a diagram illustrating in detail a case in which a base station is divided into a Central Unit (CU) and a Distributed Unit (DU).

Referring to FIG. 16, base stations W20 and W30 may be connected to a core network W10. The base station W30 may be connected to a neighbor base station W20. For example, an interface between the base stations W20 and W30 and the core network W10 may be referred to as an NG. An interface between the base station W30 and the neighbor base station W20 may be referred to as an Xn.

The base station W30 may be divided into a CU W32 and DUs W34 and W36. That is, the base station W30 may be hierarchically divided and operated. The CU W32 may be connected to one or more DUs W34 and W36. For example, an interface between the CU W32 and the DU W34, W36 may be referred to as an F1. The CU W32 may perform a function of higher layers of the base station. The DU W34, W36 may perform a function of lower layers of the base station. For example, the CU W32 may be a logical node that hosts Radio Resource Control (RRC), Service Data Adaptation Protocol (SDAP) and Packet Data Convergence Orotocol (PDCP) layers of the base station (e.g., gNB). The DU W34, W36 may be a logical node that hosts Radio Link Control (RLC), Media Access Control (MAC) and physical (PHY) layers of the base station. Alternatively, the CU W32 may be a logical node that hosts RRC and PDCP layer of a base station (e.g., en-gNB).

An operation of the DU W34, W36 may be partially controlled by the CU W32. The one DU W34, W36 may support one or more cells. One cell may be supported by only the one DU W34, W36. The one DU W34, W36 may be connected to the one CU W32, and the one DU W34, W36 may be connected to a plurality of CUs by a proper implementation.

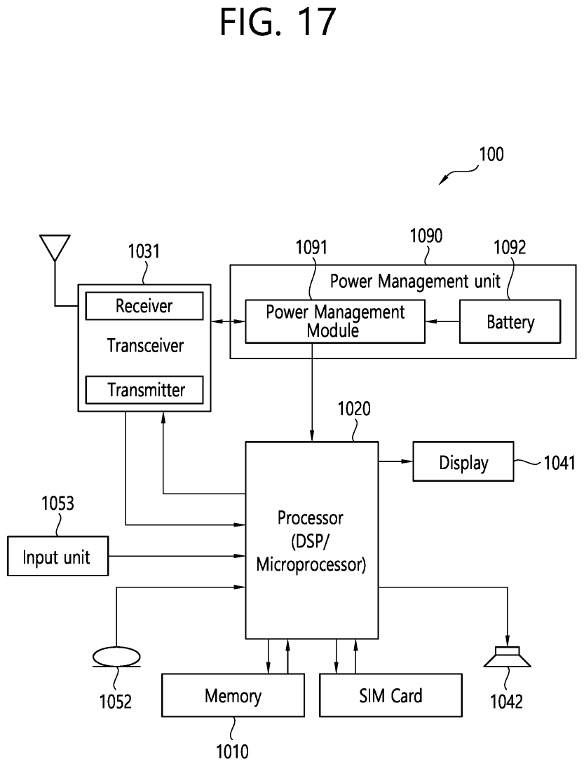

FIG. 17 is a block diagram illustrating a configuration of a UE according to an embodiment.

In particular, the UE 100 shown in FIG. 17 is a diagram illustrating the first device of FIG. 15 in more detail.

A UE includes a memory 1010, a processor 1020, a transceiver 1031, a power management module 1091, a battery 1092, a display 1041, an input unit 1053, a speaker 1042, a microphone 1052, a Subscriber Identification Module (SIM) card, and one or more antennas.

The processor 1020 may be configured to implement the proposed function, process and/or method described in the present disclosure. Layers of a wireless interface protocol may be implemented in the processor 1020. The processor 1020 may include Application-Specific Integrated Circuit (ASIC), other chipset, logical circuit and/or data processing apparatus. The processor 1020 may be an Application Processor (AP). The processor 1020 may include at least one of a Digital Signal Processor (DSP), a Central Processing Unit (CPU), a Graphics Processing Unit (GPU) and a Modulator and Demodulator (Modem). An example of the processor 1020 may be SNAPDRAGON™ series processor manufactured by Qualcomm®, EXYNOS™ series processor manufactured by Samsung®, A series processor manufactured by Apple®, HELIO™ series processor manufactured by MediaTek®, ATOM™ series processor manufactured by INTEL®, or the corresponding next generation processor.

The power management module 1091 manages a power for the processor 1020 and/or the transceiver 1031. The battery 1092 supplies power to the power management module 1091. The display 1041 outputs the result processed by the processor 1020. The input unit 1053 receives an input to be used by the processor 1020. The input unit 1053 may be displayed on the display 1041. The SIM card is an integrated circuit used to safely store International Mobile Subscriber Identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include Read-Only Memory (ROM), Random Access Memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 such that a user identifies it or for convenience.

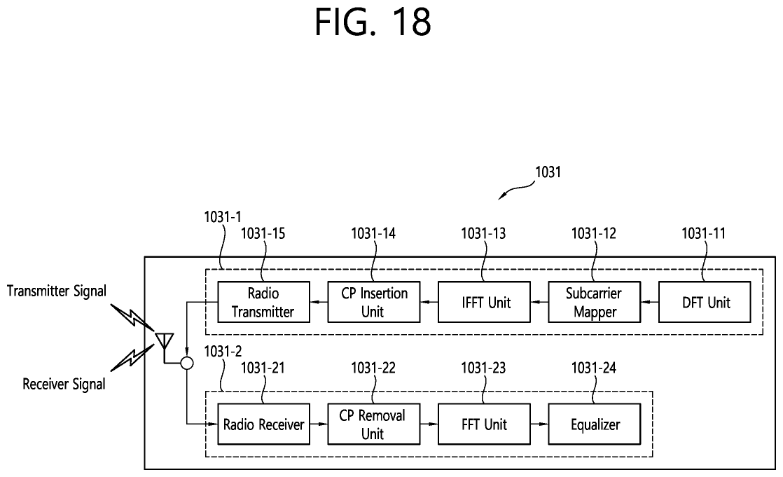

FIG. 18 is a detailed block diagram illustrating the transceiver of the first device shown in FIG. 15 or the transceiver of the device shown in FIG. 17 in detail.

Referring to FIG. 18, the transceiver 1031 includes a transmitter 1031-1 and a receiver 1031-2. The transmitter 1031-1 includes a Discrete Fourier Transform (DFT) unit 1031-11, a subcarrier mapper 1031-12, an Inverse Fast Fourier Transform (IFFT) unit 1031-13 and a CP insertion unit 1031-14, and a radio transmitter 1031-15. The transmitter 1031-1 may further include a modulator. In addition, for example, a scramble unit (not shown), a modulation mapper (not shown), a layer mapper (not shown) and a layer permutator (not shown) may be further included and may be disposed before the DFT unit 1031-11. That is, in order to prevent an increase in the Peak-to-Average Power Ratio (PAPR), the transmitter 1031-1 passes information through the DFT 1031-11 before mapping a signal to a subcarrier. After subcarrier mapping, by the subcarrier mapper 1031-12, of the signal spread (or precoded in the same sense) by the DFT unit 1031-11, a signal on the time axis is made through the IFFT unit 1031-13.

The DFT unit 1031-11 outputs complex-valued symbols by performing DFT on input symbols. For example, when Ntx symbols are input (Ntx is a natural number), the DFT size is Ntx. The DFT unit 1031-11 may be referred to as a transform precoder. The subcarrier mapper 1031-12 maps the complex symbols to each subcarrier in the frequency domain. The complex symbols may be mapped to resource elements corresponding to resource blocks allocated for data transmission. The subcarrier mapper 1031-12 may be referred to as a resource element mapper. The IFFT unit 1031-13 outputs a baseband signal for data that is a time domain signal by performing IFFT on an input symbol. The CP insertion unit 1031-14 copies a part of the rear part of the baseband signal for data and inserts it in the front part of the baseband signal for data. Inter-Symbol Interference (ISI) and Inter-Carrier Interference (ICI) are prevented through CP insertion, so that orthogonality can be maintained even in a multi-path channel.

On the other hand, the receiver 1031-2 includes a radio receiver 1031-21, a CP remover 1031-22, an FFT unit 1031-23, and an equalizer 1031-24, etc. The radio receiver 1031-21, the CP removing unit 1031-22, and the FFT unit 1031-23 of the receiver 1031-2 performs the reverse function of the radio transmitter 1031-15, the CP insertion unit 1031-14 and the IFFT unit 1031-13 of the transmitter 1031-1. The receiver 1031-2 may further include a demodulator.

<Scenario to which the Disclosure of the Present Specification can be Applied>

Although not limited thereto, various descriptions, functions, procedures, suggestions, methods and/or operational flowcharts of the disclosures of the present specification disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

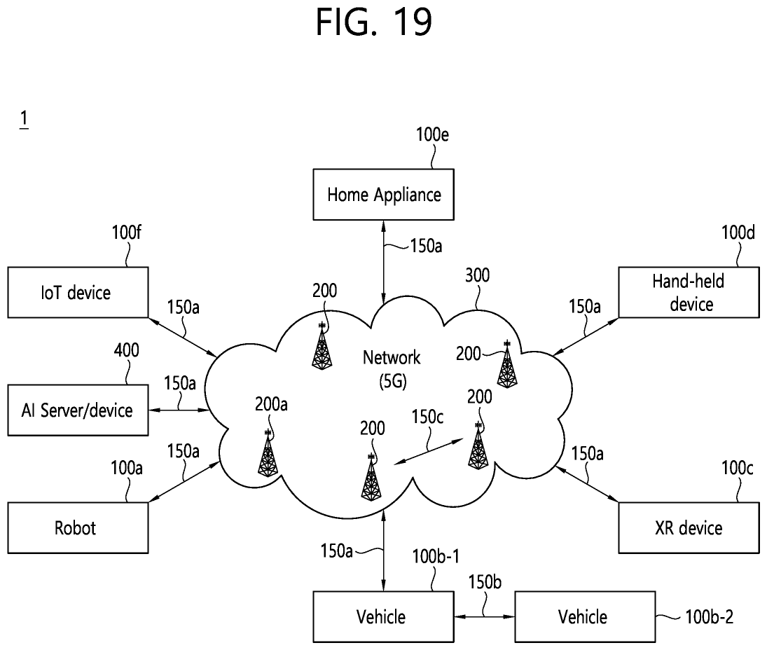

FIG. 19 illustrates a communication system 1 applied to the disclosure of the present specification.

Referring to FIG. 19, the communication system 1 applied to the disclosure of the present specification includes a wireless device, a base station, and a network. Here, the wireless device refers to a device that performs communication using a radio access technology (e.g., 5G New RAT (NR)), Long-Term Evolution (LTE)), and may be referred to as a communication/wireless/5G device. Although not limited thereto, the wireless device may include a robot 100a, a vehicle 100b-1, 100b-2, an eXtended Reality (XR) device 100c, a hand-held device 100d, and a home appliance 100e, an Internet-of-Things (IoT) device 100f, and an AI device/server 400. For example, the vehicle may include a vehicle equipped with a wireless communication function, an autonomous driving vehicle, a vehicle capable of performing inter-vehicle communication, and the like. Here, the vehicle may include an Unmanned Aerial Vehicle (UAV) (e.g., a drone). XR devices include Augmented Reality (AR)/Virtual Reality (VR)/Mixed Reality (MR) devices, and may be implemented in the form of a Head-Mounted Device (HMD), a Head-Up Display (HUD) provided in a vehicle, a television, a smartphone, a computer, a wearable device, a home appliance, a digital signage, a vehicle, a robot, and the like. The hand-held device may include a smartphone, a smart pad, a wearable device (e.g., a smart watch, smart glasses), a computer (e.g., a laptop computer), and the like. Home appliances may include a TV, a refrigerator, a washing machine, and the like. The IoT device may include a sensor, a smart meter, and the like. For example, the base station and the network may be implemented as a wireless device, and the specific wireless device 200a may operate as a base station/network node to other wireless devices.

The wireless devices 100a to 100f may be connected to the network 300 via the base station 200. An Artificial Intelligence (AI) technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the base stations 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-Everything (V2X) communication). The IoT device (e.g., a sensor) may perform direct communication with other IoT devices (e.g., sensors) or other wireless devices 100a to 100f.

Wireless communication/connections 150a, 150b and 150c may be established between wireless device 100a to 100f and base station 200, between base station 200/base station 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the base station 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

In the above, preferred embodiments have been exemplarily described, but the disclosure of the present specification is not limited to such specific embodiments. Therefore, the disclosure of the present specification may be modified, changed, or improved in various forms within the present specification and the scope set forth in the claims.

In the exemplary system described above, the methods are described on the basis of a flowchart as a series of steps or blocks, but are not limited to the order of the steps described, some steps may occur in a different order or concurrent with other steps as described above. In addition, those skilled in the art will understand that the steps shown in the flowchart are not exclusive and that other steps may be included or that one or more steps of the flowchart may be deleted without affecting the scope of rights.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim of the present specification may be combined to be implemented as an apparatus, and the technical features of the method claim of the present specification and the technical features of the apparatus claim of the present specification may be combined and implemented as a method.

1. A method for an Access and mobility Management Function (AMF) device in a first network to process a request from a User Equipment (UE), the method comprising:
receiving, by the AMF device in the first network, a first request message from the UE which supports multiple Universal Subscriber Identity Modules (USIMs) and has received a paging message from a second network,
wherein the first request message includes information on one or more Protocol Data Unit (PDU) sessions and information on release;
transmitting, by the AMF device, a second message to a Session Management Function (SMF) device in the first network;
wherein the second message includes information on the one or more PDU sessions based on the first request message; and
performing, by the AMF device, a procedure for releasing with a Radio Access Network (RAN) in the first network.

2. The method of claim 1, wherein the method further comprises determining an SMF device managing or serving each PDU session, based on the information on the one or more PDU sessions included in the first request message received from the UE.

3. The method of claim 2, wherein, in case that there is a plurality of the determined SMF devices, the second message is transmitted to the plurality of the determined SMF devices.

4. The method of claim 1, wherein the second message is used by the SMF device to request deletion of downlink data from a User Plane Function (UPF) device.

5. The method of claim 1, wherein the second message is used by the SMF device to request not transmitting further downlink data to a User Plane Function (UPF) device.

6. The method of claim 1, wherein the one or more PDU sessions are suspended, based on the first request message and the second message.

7. The method of claim 1, wherein the method further comprises:
receiving, by the AMF device, a second request message from the UE; and
transmitting, by the AMF device, a third message to the SMF device based on receiving the second request message.

8. The method of claim 7, wherein the third message is used to enable the SMF device to transmit a paging message for downlink data.

9. The method of claim 7, wherein the method further comprises transmitting, by the AMF device, an accept message for the second request message to the UE.

10. An Access and mobility Management Function (AMF) device in a first network to process a request from a User Equipment (UE), the AMF device comprising:
at least one processor; and
at least one memory operably electrically connectable to the at least one processor and storing instructions that, based on being executed by the at least one processor, perform operations comprising:
receiving a first request message from the UE which supports multiple Universal Subscriber Identity Modules (USIMs) and has received a paging message from a second network;
transmitting a second message to a Session Management Function (SMF) device in the first network; and
performing a procedure for releasing with a Radio Access Network (RAN) in the first network,
wherein the first request message includes information on one or more Protocol Data Unit (PDU) sessions and information on release, and
wherein the second message includes information on the one or more PDU sessions based on the first request message.

11. The AMF device of claim 10, wherein the operations further comprise determining an SMF device managing or serving each PDU session, based on the information on the one or more PDU sessions included in the first request message received from the UE.

12. The AMF device of claim 11, wherein, in case that there is a plurality of the determined SMF devices, the second message is transmitted to the plurality of the determined SMF devices.

13. The AMF device of claim 10, wherein the second message is used by the SMF device to request deletion of downlink data from a User Plane Function (UPF) device.

14. The AMF device of claim 10, wherein the second message is used by the SMF device to request not transmitting further downlink data to a User Plane Function (UPF) device.

15. The AMF device of claim 10, wherein the one or more PDU sessions are suspended, based on the first request message and the second message.

16. (canceled)
